(19) United States
(12) Patent Application Publication
(10) Pub. No.: US 2007/0055550 A1
(43) Pub. Date: Mar. 8, 2007

(54) Personal transportable healthcare data base

(75) Inventors: Douglas Courtney, Palm Coast, FL (US); Naomi F. Melvin, Chipley, FL (US)

Correspondence Address: JOEL I ROSENBLATT, 445 11TH AVENUE, INDIALANTIC, FL, 32903, US

(73) Assignee: Patient Practitioners LLC

(21) Appl. No.: 11/220,162

(22) Filed: Sep. 6, 2005

(51) Int. Cl. G06F 19/00; G06F 17/00

(52) U.S. Cl. 705/3; 235/375; 707/104.1; 715/507

(57) ABSTRACT

A personal transportable patient healthcare data base. The data base includes data processes for storing bar coded specific health care information classified by general health care classifications. A data entry may be by entering a respective bar code for a specific healthcare fact. A warning notice for a specific healthcare fact may be displayed in response to the bar coded entry.

### BACKGROUND

Healthcare data bases are used widely, particularly in the offices of healthcare practitioners, requiring an electronic medical record system capable of separately storing the records of multiple patients, or of accessing a central store, for reading the current healthcare facts of widely dispersed patients or for revision of those records.

While central data bases can be used efficiently, particularly where a patient may require medical treatment at a location away from home, there is a need to have an up to date and current data base, wherever the patient may be and whenever there is an urgent need for immediate or prompt access to patient healthcare facts needed for immediate diagnosis or treatment.

However, a personal transportable healthcare data base, providing immediate access to current patient records, should be usable by the patient or the practitioner, to identify and enter the various specific healthcare faces for a patient, within a related general healthcare classification. The data base process should have a notice or warning system for identifying conflicts or problems with new and existing treatments or prescriptions.

To be efficient, the data base should include a bar code system that stores a library of easily accessibly healthcare facts, for example, medications, surgeries, allergies, for selection and bar code entry of the related data into the data base.

Provisions should be made for direct entry of specific healthcare facts by a doctor into the patient data base or for import or export, of patient data between a patient and the practitioner's electronic medical record data base system.

These problems of patient healthcare data base systems are solved by the invention disclosed herein.

### SUMMARY

This invention provides a personal transportable healthcare data base record that provides bars coded listings of healthcare facts for inventive principles disclosed in a preferred embodiment comprise a personal portable patient healthcare data base program, which may be stored in a computer hard drive or on a magnetic, optical, or other suitable medium for storing data. While it may be stored on a centralized store, the advantage of the invention is in a portable transportable data base that can be everywhere the patient may be and which may be presented to a practitioner or exported into the practitioner electronic medical record (“EMR”), as the patient's current medical information, as may be required for immediate treatment.

In a preferred embodiment the database is arranged in relatable records, as would be known to those skilled in the art. In a preferred embodiment, the data is stored in relatable tables, as is understood by those skilled in the art. The data base program may comprise a data input and output process, for example, as would be known in a windows computer operating display system, a data insertion display and a data output process comprising a data output display.

However, as would be understood by those skilled in the art, any other data input or output process may be used, as shown in a preferred embodiment, for the insertion of specific healthcare facts, within respective general healthcare classifications or for the insertion of bar codes representing specific healthcare facts or the names of the specific health care facts, which is now known or hereafter developed without departing from the disclosed inventive principles.

The inventive principles as disclosed for data base program includes a data process connecting the data records with the data inserted in the data insertion display and the data presented for viewing in the data output display.

In a preferred embodiment, a bar code is used to represent healthcare facts. The bar coded healthcare facts may comprise a plurality of specific healthcare facts, within respective general healthcare facts. In a preferred embodiment, for example, within the general healthcare facts of medications and prescriptions, a listing may be presented as a scrollable listing, of the specific medications and prescriptions, available for prescription, or which has been prescribed. The listing may be of the specific healthcare facts and the corresponding bar codes, and may be presented in a scrollable listing, as would be understood by those skilled in the art. In a preferred embodiment, for a specific healthcare fact, there is a matching bar code number, which may be scanned for placing the bar coded information in the data base, or may be typed into the bar code data insertion window or may be inserted by highlighting the selected bar code and selecting the highlighted bar code for insertion into the data base for the general healthcare classification table. When inserted in a data record, the specific healthcare fact may be displayed and printed.

Other general health care classifications, as shown for a preferred embodiment, are for compounds or supplements, surgical procedures, laboratory procedures, x-ray procedures, and miscellaneous medical procedures. However, other general healthcare classifications may be added without departing from the disclosed inventive principles.

As shown in a preferred embodiment, the data base comprises bar coded healthcare facts comprising specific healthcare facts within respective general healthcare classifications and may be a proprietary code. In a preferred embodiment, the bar code may be in a seven-position code with the general healthcare classification in the most signification position. For example, Medications and Prescriptions may be coded by a “1”, Surgical Procedures by a “4,” Laboratory Procedures by a “3,” X-Ray Procedures by a “5,” Miscellaneous Medical Procedures by “2,” the doctor's or physician's diagnosis by a “6,” and wherein other general healthcare classifications identified by other numerals or codes, as would be understood by those skilled in the art, may be used without departing from the disclosed inventive principles.

As shown in a preferred embodiment, the data process or program for entering and displaying data and for arranging the data within a set of related data tables, within the data base, comprises a process for placing in at least one of the relatable records which is identified with a respective general healthcare classification, a specific healthcare fact corresponding to a respective bar code. In a preferred embodiment, the bar code for specific healthcare facts would be coded for the respective general healthcare classification.

In a preferred embodiment, the data base data input process may identify from a listing, a bar code for a specific healthcare fact entered in a data insertion display or a specific healthcare fact for a bar code entered in a data insertion display. The displays for identifying the bar code from the specific healthcare fact or the specific healthcare fact from the bar code may be separate from the process for entering the specific healthcare fact into the data base records by entering the respective bar code in a bar code insertion display. As would be understood by one skilled in the art, the data entry may be by highlighting the selected specific healthcare fact or bar code, from a listing of healthcare facts and selecting the highlighted bar code or specific health care fact for entry into the respective general healthcare classification table. As would be understood by one skilled in the art, the listing may be a scrollable listing.

In the disclosed inventive principles, as shown in a preferred embodiment, the input process may comprise a display or screen with a list of a plurality of specific health care facts within or with respect to a general healthcare classification. The listing, as shown in preferred embodiment, may be in scroll down list as would be understood by those skilled in the art, wherein a patient or a practitioner, may select from the specific healthcare fact or bar code, as presented in the display or screen.

In a preferred embodiment, the specific healthcare facts, as may be arranged in respective general healthcare facts, may be presented in a report in a data output display or screen and may include the respective graphic bar code. The data base may comprise a process for printing the displayed report with the graphic and numeric respective bar code. The printed report may be used, as described in a preferred embodiment, for inserting the bar code information by bar coded scanning or by insertion of the bar coded value.

In a preferred embodiment, the scanned bar code for a specific healthcare fact, may be inserted through by means of, the input display for the corresponding general healthcare fact. As shown in a preferred embodiment, a data insertion display may comprise at least one data input display for a respective general healthcare classification, the process presenting a plurality of bar coded specific healthcare facts for said respective general healthcare classification, and with insertion of the correct bar code for a specific healthcare fact as may be selected from the plurality of bar codes and corresponding healthcare facts, into the bar code insertion display or from a scanned bar code.

In the disclosed inventive principles, as shown for a preferred embodiment, at least one data output display includes a plurality of navigation points and a data process opening a respective output display for a general healthcare fact corresponding to at least of the navigation points. In this process, navigation from one data output display for one respective general healthcare fact, to one or more other general healthcare facts, is provided.

One of the navigation points presented in an data output display, may be to a patient information input display or screen, as shown in a preferred embodiment with a process for inserting graphic images into relatable records. Generally, the graphic images may be produced by a physiological exposure to electrical, light, or magnetic, waves, or sound wave, comprising exposure to x-rays or from an analysis of biological material, as would be understood by those skilled in the art. The graphic image may be a picture of the patient or the DNA analysis of the patient, for example.

As shown in a preferred embodiment, there is a main page or screen, for displaying general information about the patient, comprising the patient's name, contact information, the primary care physician, and the physician's contact information, and specific healthcare facts, which are necessary or desirable in an emergency or urgent situation. As shown in preferred embodiment, the main page may comprise information of the patient's current medical condition, recent surgeries, recent out of country visits, and may include navigation points to a patient input information display, a doctor's or practitioner's input display, and to data output displays for allergies, x-rays, current medical condition, medications, compounds, supplements, physician diagnosis, laboratory procedures, immunizations, other information, family history. The main page may comprise navigation points to a patient input display comprising one or more navigation points to other displays or screens with respect to general healthcare facts and for entering specific healthcare facts for the respective general healthcare fact, or to an input display or screen for a doctor or physician to insert specific healthcare facts.

According to the inventive principles, as disclosed in a preferred embodiment, the data base program may comprise a data process for importing or exporting specific healthcare facts between a patient data base and a practitioner data base, know and understood by those skilled in the art as an electronic medical record (“EMR”). The particular system or method for the transfer itself would be dependent on arranging data systems to be compatible and would be known to those skilled in the art, as explained for a preferred embodiment.

The data process for importing or exporting specific health care facts may comprises a data selection process for a selection of respective general healthcare classifications or specific healthcare facts, within a general healthcare classification.

In a preferred embodiment, the data input process may comprise one or a plurality of displays for entering or inserting data. Where data is repeatedly entered, for example, the relevant practitioner and practitioner contact data, for any healthcare facts, the data base data input process may comprises a process for storing for selection, information repeatedly entered and for presenting the repeatedly entered information, for example in a screen drop down menu, for selection and insertion in a respective record.

According to the disclosed inventive principles, as shown in a preferred embodiment, the data base program, may comprise, in at least one of the data base records, notices for respective specific healthcare facts. The notice may be produced in an output display in response to a bar coded healthcare fact, inserted in a data input display. In a preferred embodiment, the notice is produced as an overlay screen. The notice may be presented in a noticeable color like red or yellow and with the notice contained in the overlay window. The notice, with respect to an inserted bar code, may display a warning of adverse use for example, for use of a medication in connection with other medications whether or not prescribed or taken by the patient or in connection with surgeries or allergies or immunizations, shown or recorded in the patient data base record.

The notice, as shown in a preferred embodiment, may be information for a medicine or supplement specific healthcare fact, for example, of an adverse response, outcome, or reaction, to, or for, or from, one or more of said bar coded healthcare facts, inserted in the data base or in response to data inserted in the data base and related general or specific healthcare facts resident in the data base.

In a preferred embodiment, the notice, whether from the same or a separate general classification as the inserted specific healthcare fact, may comprise information of an adverse response, outcome, or reaction, to, or for, or from, one or more of said bar coded healthcare facts. The notice may, present, or advise, or warn, of information of an adverse outcome for a surgical or other procedure, or from a medication or pharmaceuticals, or to an immunization, for example.

According to the disclosed inventive principles and as shown in a preferred embodiment, the data base program may comprise a doctor's data input process comprising; a plurality of separate data insertion displays for respective general healthcare classifications and connecting the records of a doctor or practitioner, with the data inserted in the doctor's data insertion display.

In a system and method similar to the patient data insertion process, the doctor's data input process may start with the data process for identifying a bar code for a specific healthcare fact, or a specific healthcare fact for a bar code, in response to a respective healthcare fact or bar code and then insertion of the bar code in the bar code insertion display, or the doctor or practitioner, may insert the bar code directly in the bar code insertion display, for recording the bar coded specific healthcare fact in a respective general healthcare classification.

The doctor or practitioner's records may arrange the specific healthcare facts for a respective general healthcare classification, in a report and said data output display may comprise a bar code for at least one specific healthcare facts.

In addition to inserting a bar code for a specific healthcare fact in a general healthcare fact data insertion display and into the doctor's records, the data input process may comprise reading a bar code from bar coded information, as would be understood by one skilled in the art.

In the method or the system for importing or exporting information, as described above, the records for a patient may be imported to or exported from the EMR records of a practitioner and with the same for the reverse process of records exported from the practitioner to the patient or imported from the patient to the practitioner.

In accordance with the disclosed inventive principles, as shown for a preferred embodiment, the bar coded healthcare facts are for respective general healthcare classifications are of general information, or immunizations, or medications or prescriptions, or supplements or compounds, or surgical procedures, or laboratory procedures, other procedures, or doctor's visits or diagnoses, or family medical history, or foreign countries visited, or a personal photo, or DNA analysis, or graphic images from x-ray or other imaging procedures, or physiological analysis, for example of blood or tissue. Other general classifications may be added without departing from the disclosed inventive principles.

As shown in a preferred embodiment, the data output process comprises a process for displaying in the data output display, at least one notice, in response to a bar code for a specific healthcare fact and a respective general healthcare classification, inserted in said data input display for a separate respective general healthcare classification.

As shown for a preferred embodiment, the notice comprises information of an adverse response, outcome, or reaction, to, or for, or from, one or more specific healthcare facts, in response to the insertion of a said bar code for a said respective healthcare fact.

As shown for a preferred embodiment, the notices comprise information of an adverse outcome for a surgical or other procedure, or from a medication or pharmaceuticals, or to an immunization.

However as would be understood by those skilled in the art, other specific healthcare facts as now or hereafter known may be included in the notices.

### DESCRIPTION OF THE DRAWINGS

FIG. 1 is the data base Main Page, data output display screen, displaying patient contact data and primary patient history data and navigation points to other data output displays and to data input displays.

FIG. 2 is the data base Patient Information Input Screen, accessible from the navigation point in the Main Page, FIG. 1, and providing navigation points to the data base system data input displays.

FIG. 3 is the data base Patient Personal Input Screen accessed from the Patient Information Input Screen, as shown in FIG. 2

FIG. 3a is the Patient Personal Input Screen continuation for inserting personal data into the data base, additional to the data inserted in the data input display of FIG. 3.

FIG. 4 is the data base data insertion display for inserting immunization data in the data base record.

FIG. 5 is the data base insertion display for inserting patient data for medicines and prescriptions.

FIG. 6 is the data base output display for showing a warning notice as an overlay for a specific pharmaceutical Arcabose, as an example.

FIG. 6a is the data base warning notice, as shown in FIG. 6, displayed by itself without an overlay.

FIG. 7 is the Medicine and Prescription continuation sheet for entering additional information about data inserted in the data insertion display of FIG. 5.

FIG. 7a is the Medicine and Prescription continuation sheet of FIG. 7, with a drop down display for entering recurrent information.

FIG. 8 is the data insertion display to Record Compounds and Supplements Used.

FIG. 9 is the data input display to Put Surgical Procedures in the Records.

FIG. 10 is the second screen continuation to data input display to Put Surgical Procedures in the Records, FIG. 9.

FIG. 11 is the data insertion display to Put Laboratory Procedures in the patient's Record.

FIG. 12 is the second continuation data insertion display to Put Laboratory Procedures in the patient's Record.

FIG. 13 is the data input display to Put X-Ray Procedures in the Medical Record.

FIG. 14a is the Put X-Ray Procedures in the Medical Record data insertion display second page.

FIG. 14b is the data entry display for entering a digital x-ray image.

FIG. 15 is the data input display to Put Miscellaneous Procedures in the Medical Record.

FIG. 16 is the data input display to Put Miscellaneous Procedures in the Medical Record, second page.

FIG. 17 is the data input display to make a Record of Family History.

FIG. 18 is the data input display to Put Doctor's Diagnosis in the Medical Records.

FIG. 19 is the data input display to Put Doctor's Diagnosis in the Medical Records, 2^{nd} page.

FIG. 20 is the data input display for Record Foreign Countries Recently Visited.

FIG. 21 is the data input display to put a Personal Photo in the Record.

FIG. 22 shows a data output display for the Main Page, FIG. 1, displaying the data inserted in the data base record, including current medical condition inserted through the Put Doctor's Diagnosis data insertion display, see FIG. 18, and the navigation points to the other data output displays and to the data insertion displays.

FIG. 23 shows a data output display of a report of the patient's x-rays with navigation points for viewing or printing the x-rays, for example in a single series of x-rays, as shown for a preferred embodiment.

FIG. 24 shows a data output display for the Allergies general healthcare classification, displaying the data inserted in the data base record and the navigation points to the other data output displays.

FIG. 25 shows a data output display for the Medications and Compound general healthcare classification, displaying the data inserted in the data base record and the navigation points to the other data output displays.

FIG. 26 shows a data output display for the Medications Compound general healthcare classification, displaying a report of the data inserted in the data base record and the bar codes for the respective medications and compounds, inserted in the data base record.

FIG. 27 shows a data output display for the Medications Compound general healthcare classification, displaying a report, by date of the respective medication or compound data, as shown in FIG. 26, with the data selected by the date.

FIG. 28 shows a data output display in the Main Page, as shown in FIG. 1, and FIG. 22, for the Physician's Diagnosis general healthcare classification, displaying the data inserted in the data base record and the navigation points to the other data output displays.

FIG. 29 shows a data output display for the Laboratory Data general healthcare classification, displaying the data inserted in the data base record and the navigation points to the other data output displays.

FIG. 30 shows a data output display for the Other Immunizations general healthcare classification, displaying the data inserted in the data base record and the navigation points to the other data output displays.

FIG. 31 shows a data output display for the Family History general healthcare classification, displaying the data inserted in the data base record and the navigation points to the other data output displays.

FIG. 32 shows a data output display for the patient's DNA analysis data inserted in the data base record.

FIG. 33 shows the data insertion display for the Doctor's Input Screen For The Development of Medical Reports—Medications and Prescriptions.

FIG. 34 shows the data output display of a report of the Doctor inserted medications and prescriptions, with the respective bar codes.

FIG. 35 shows the data insertion display for the Doctor's Input Screen For The Development of Medical Reports—Laboratory Procedures.

FIG. 36 shows the data output display of a report of the Doctor inserted Laboratory Procedures, with the respective bar codes.

FIG. 37 shows the data insertion display for the Doctor's Input Screen For The Development of Medical Reports—Diagnosis.

FIG. 38 shows the data output display of a report of the Doctor inserted Diagnosis with the respective bar codes.

FIG. 39 shows the data insertion display for the Doctor's Input Screen For The Import of EMR information from the patient data base to the practitioner EMR.

FIG. 40 shows a data output display of a report of the patient's personal information.

FIG. 41 shows as an example, the data base table design for the Allergies data base table, as would be used, in a preferred embodiment, for importing the specific healthcare facts for that respective general healthcare classification, from the patient data base to a practitioner EMR.

### DETAILED DESCRIPTION OF THE INVENTION

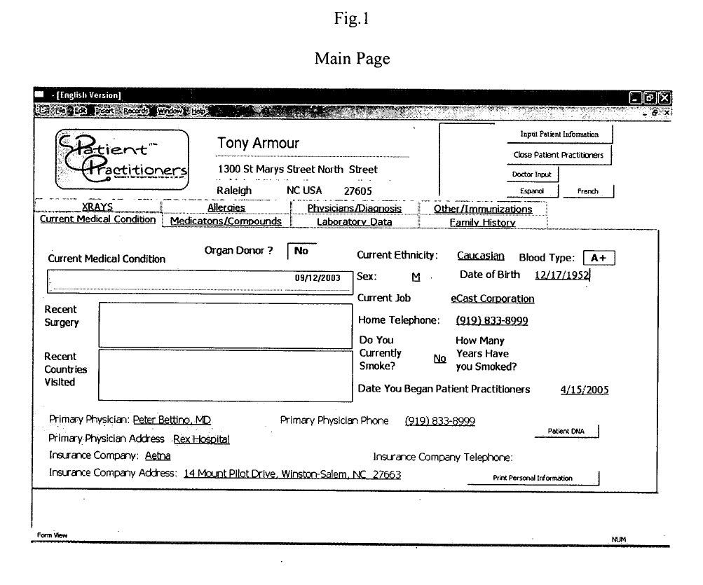

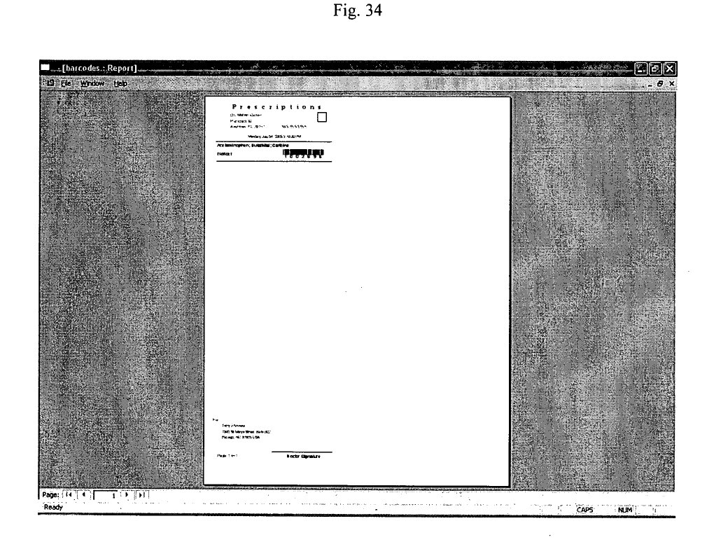

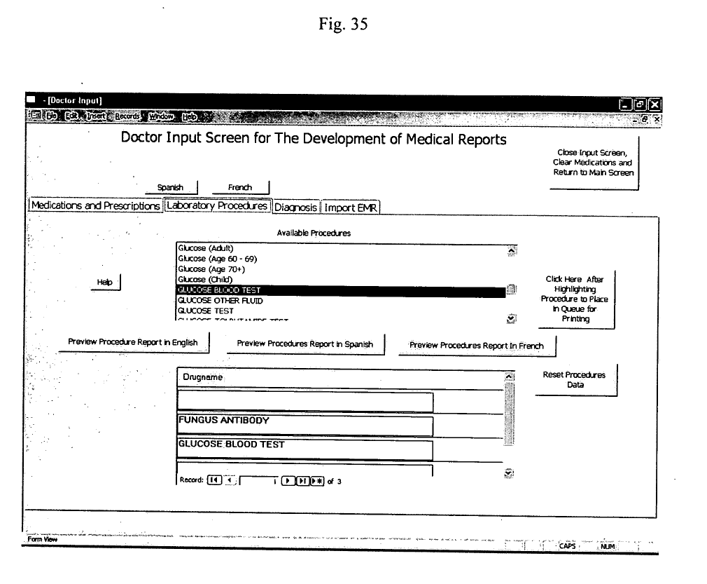

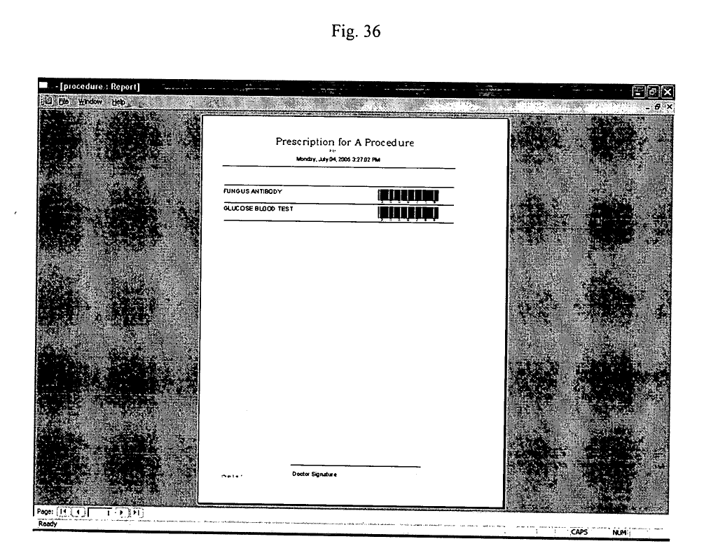

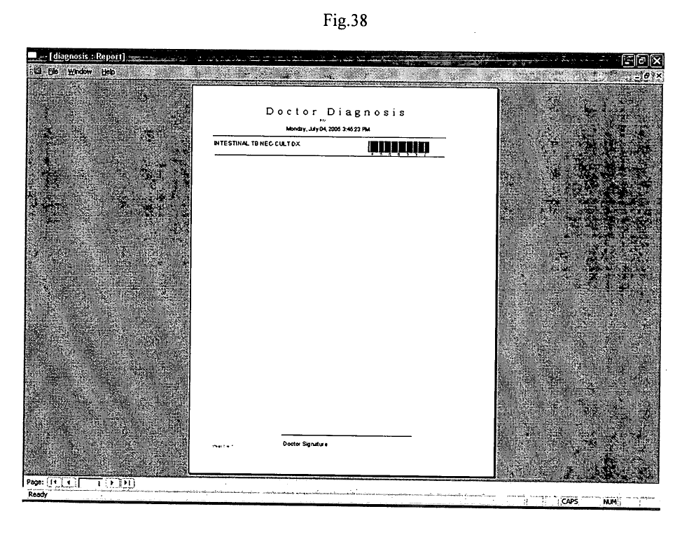

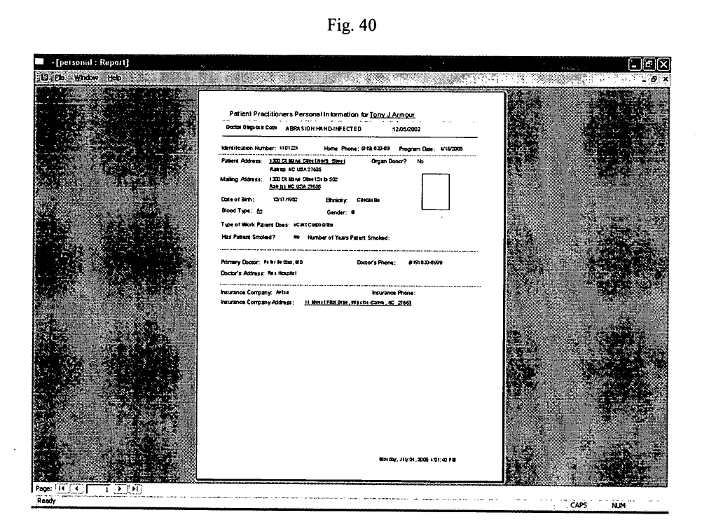

The disclosed inventive principles for a preferred embodiment, are described with reference to the FIGS. 1 to 41, showing the invention's data base system and method for entering and ordering, information into a healthcare data base and for displaying the data in output displays and printed reports, bar coded with specific healthcare information. The invention, as may be practiced in a preferred embodiment, may use a commercially available windows style data base, for example, the Microsoft Access™ data base operated by a commercially available IBM™ compatible computer with a suitable operating system, as would be understood by those skilled in the art. The data base data processes for recording, ordering, displaying, printing, or exporting or importing information, may be practiced with any suitable data processing system or method, as known or hereafter developed, which is not part of the disclosed inventive principles.

Windows computer applications, as is well known by those skilled in the art, uses a windows style graphical user interface, as may be known by users of Apple™ and IBM™ compatible computer software applications. The disclosed inventive system and method, in a preferred embodiment, uses a series of windows screen displays with data insertion and display windows, set in a screen mask, as would be known to those skilled in the art. The data base data processes are used for the insertion and retrieval of healthcare information, in connection with a relational data base, and for arranging the information for presentation in a plurality of output displays and reports. The systems and methods for data entry masks and for the presentation of data output in mask screens, are well know, are available, for example, as part of the Access™ data base program and are not part of the disclosed inventive principles. As would be understood by those skilled in the art, the display system or method, used for inserting or displaying, information may be any known or hereafter developed method or system, without departing from the disclosed inventive principles, or the disclosed invention, comprising the disclosed arrangements for inserting data, displaying data, producing bar coded reports, or importing or exporting the data.

The inventive principles, as disclosed in a preferred embodiment, comprise a bar code for identifying selected healthcare facts and a bar code printing and reading system, for presenting the information in the data base or for inserting bar coded healthcare facts into the data base. The bar code is presented in a data display, or in a printed report, and bar coded data may be scanned into the data base records.

In a preferred embodiment, the data base, comprising its records and data processes, may be placed in a portable memory drive, as would be know to those skilled in the art. In this way, the data base may be personally transported and would be available wherever the person whose health care records are contained therein, is located. The advantages of this portable and personal health care data base are for use in trauma treatment, where core or basic patient information, is required immediately, or where a patient requires treatment away from home or at a remote location, where access to patient data is not available, and the patient is able to present a complete up to date medical history to the practitioner.

The system and method disclosed in a preferred embodiment, uses the commonly well known “point and click,” method for navigation by cursor selection of a navigation point, commonly known as a “button,” and then use of a signal initiated by a manual switch, commonly called a mouse click, to access another screen, within the system plurality of screen displays. However, as would be understood by those skilled in the art, any other suitable method or style of navigation between the screens for inserting information into the data base and for displaying the information, may be used without departing from the disclosed inventive principles.

In a preferred embodiment, each of the data insertion display screens and data output display screens, used in the insertion of identified data, or the presentation of identified stored data, with the type or kind of displayed health care data, as indicated or identified on the displayed mask, are as would be known to those skilled in the art.

In explanation of a preferred embodiment of the disclosed inventive principles, the database is arranged in a plurality of general healthcare classifications with specific healthcare facts arranged within respective general healthcare classifications.

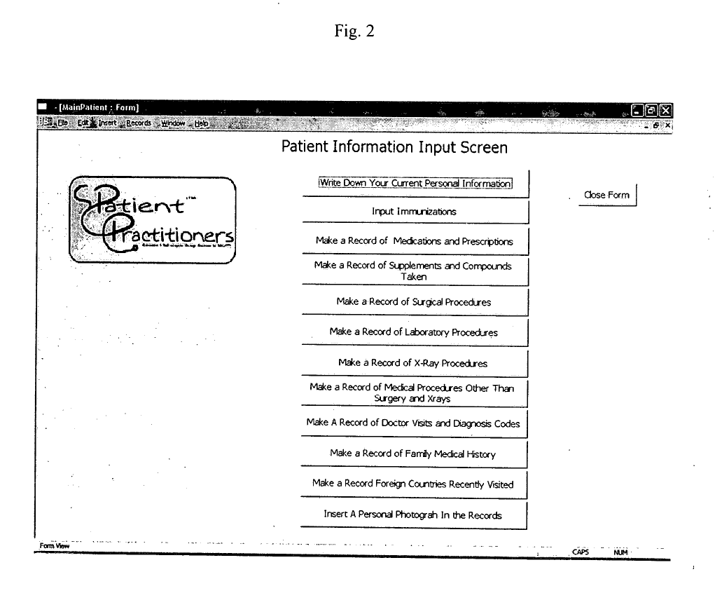

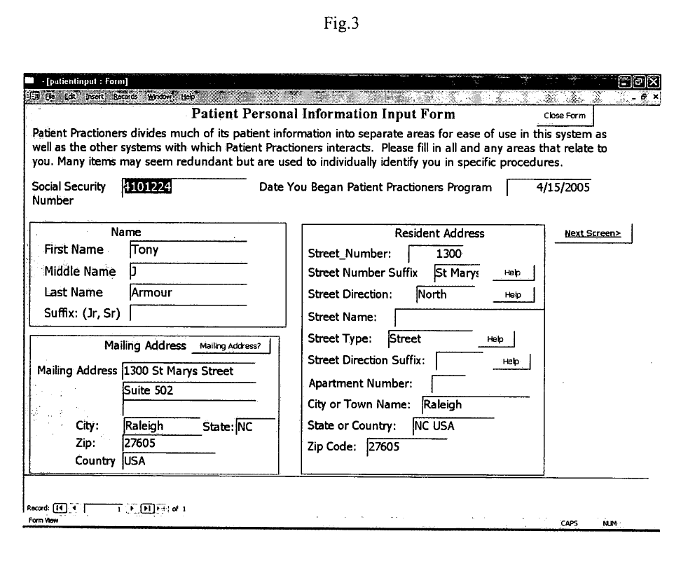

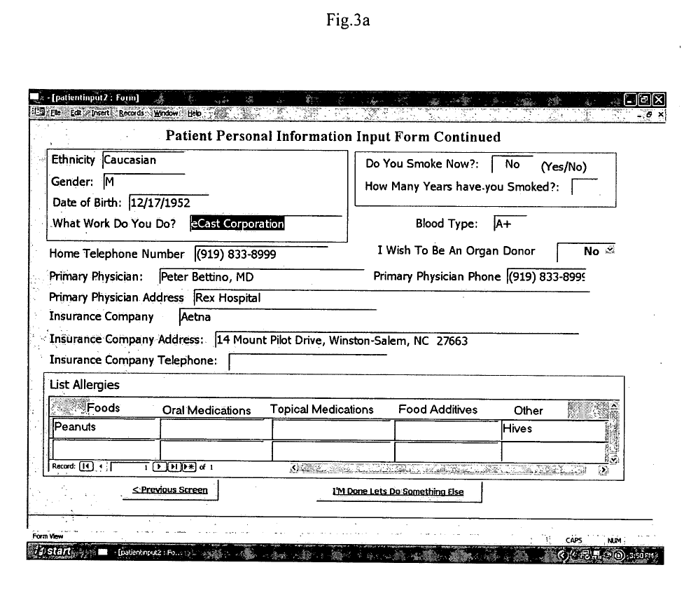

The system main page is as shown in FIG. 1. The patients ID number serving as a data base key, which is not displayed in the Main Page. That ID number may be carried through the data base records and used in data insertion display screens as shown in a preferred embodiment, for example, in FIG. 3, the Patient Personal Input Screen accessed from the Patient Information Input Screen, as shown in FIG. 2.

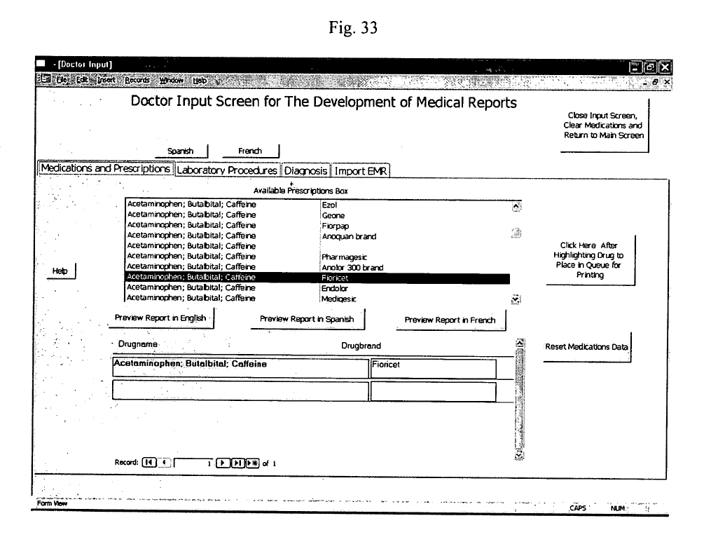

The initial screen is presented as a Main Page, FIG. 1, identified in a preferred embodiment as a general healthcare classification screen as explained in the following, for its display of general or basic patient healthcare facts, for example, the patients general condition. For a preferred embodiment, the Main Page, FIG. 1 may serve as a data insertion display as it provides navigation points to the input screens, as shown by the navigation points in FIG. 1 to input patient information through the Patient Input Information Input Screen, FIG. 2, and to the Doctor data insertion screens, as shown and described herein, in connection with FIGS. 33, 35, 37, 39.

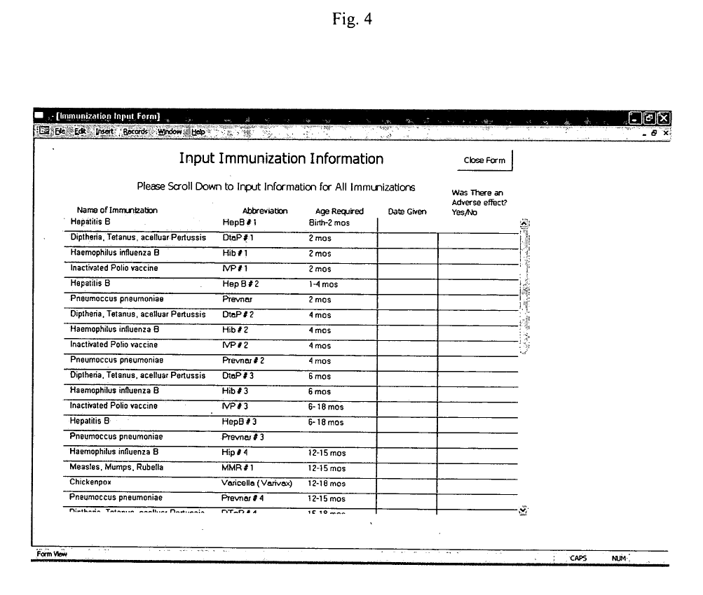

For a preferred embodiment, input screens are the means for the insertion of specific health care facts into the data base and display of the inserted specific healthcare facts in the respective general healthcare classification screens. In a preferred embodiment, the patient's specific healthcare facts are displayed or entered in relation to the respective general healthcare classification. In a preferred embodiment, the general healthcare classifications may comprise general classification healthcare basic facts. For example, proceeding from the Patient's Personal Information, navigation point, as shown in FIG. 2, to the data insertion displays as shown in FIGS. 3 and 3a, comprising the specific healthcare facts related to personal information, the patient ID, contact data for the patient and the patient's healthcare providers and insurers, allergies. As shown by the other navigation points for the general healthcare classifications in FIG. 2, the data insertion displays may be displayed for general healthcare classifications of recent surgeries, recent visits outside the patient's native country, a statement of the patient's present condition, immunizations, medications and prescriptions, supplements and compounds taken by the patient, surgical procedures, laboratory procedures, x-ray procedures, and other procedures, doctor visits and diagnosis, family medical history, foreign country visits, as shown in FIGS. 4 to 21, and as may be modified or added, as would be understood by those skilled in the art.

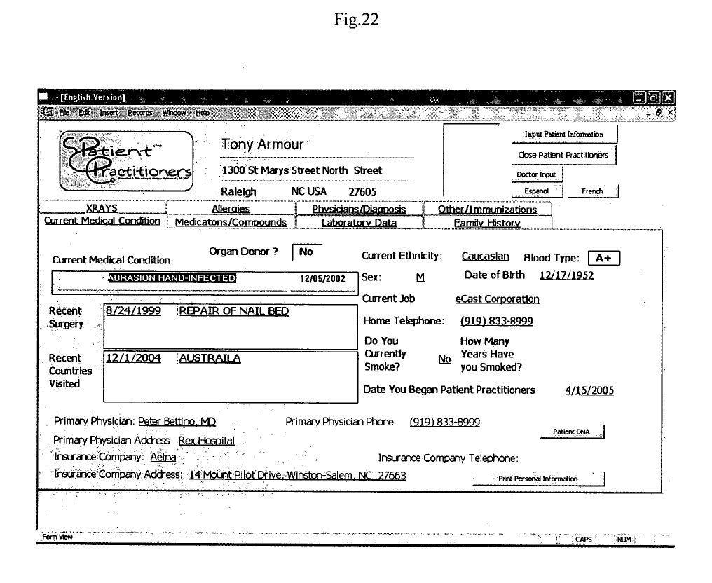

The Main Page, as shown in FIG. 1, and FIG. 22, used in a preferred embodiment as a General Healthcare Classification screen, includes windows for general or basic patient information, comprising name, address, organ donor, ethnicity, blood type, date of birth, sex, current medical condition, recent surgery, recent countries visited, smoker or not, primary care physician and insurance company, organ donor, and related facts. Without departing from the disclosed inventive principles, the Main Page, FIG. 1, may comprise other information, as may be considered useful or required in providing an immediate picture of vital health care information, as might be needed for example for critical trauma treatment.

The Main Page, FIG. 1, as shown in a preferred embodiment, may include various navigation points or buttons for navigating to others of the general healthcare classification screens, for the display of the information in the data base record, for example, X-Rays, Allergies, Medications/Compounds, Physicians/Diagnosis, Laboratory Data, Other/Immunizations, and Family History and for navigating to the Input Patient Information screen, as shown in FIG. 2, or to the Doctor Input screens as shown in FIGS. 33, 35, 37, 39.

The Patient Information Input Screen, as shown in FIG. 2, as shown for a preferred embodiment, is used by the patient to access the data insertion displays for Current Personal Information. The navigation points or points, or buttons displayed for use in a preferred embodiment, are for patient insertion of specific healthcare facts within the general healthcare classifications in a preferred embodiment, of Current Personal Information, Immunizations, Medications and Prescriptions, Supplements and Compounds Taken, Surgical Procedures, Laboratory Procedures, X-Ray Procedures, Doctor Visits and Diagnosis, Family Medical History, Foreign Country Visits, or for the insertion of a Photo, as may be seen from FIGS. 3 to 21.

The invention as shown for a preferred embodiment is explained in relation to the use of the Patient Input Screen, as shown in FIG. 2, and for designated general healthcare classifications, as shown in a preferred embodiment, sub or successive respective general healthcare classification data input displays or data input screens. For example within the input screen selection, for the insertion of specific healthcare facts within the general healthcare classification for patient's Current Healthcare Information, the patient may insert data indicative of contact information, primary care physicians and insurer and other information, for example, allergies to food, oral and topical medications, food additives, or other allergies, as shown in FIGS. 3 and 3a, the Patient's Personal Information Input Form. In a preferred embodiment, navigation, from the Patient Input Screen to the patient input displays for insertion of specific healthcare facts under respective general healthcare classifications is as shown in the example for navigation from the Write Down Your Current Personal Information, point in FIG. 2 to the data input displays of FIGS. 3 and 3a.

Referring to the Patient Information Screen, FIG. 2, the topmost or first point is presented for selection of the Patient Personal Information Input Form, and Patient Personal Information Input Form Continuation screen, as shown in FIGS. 3 and 3a. The use of masked screens, as shown in FIGS. 3 and 3a, for the entry or display of information into, or on, the data entry windows, are the same as used in the other data insertion displays and data output displays, as shown for a preferred embodiment and are as known and understood by those skilled in the art. The requested information, as indicated for insertion in the data insertion windows in FIGS. 3 and 3a, is placed in the data base record, for display on the Main Page, as shown in a preferred embodiment in FIG. 1, or in the respective the general healthcare classification display screens, which may be accessed by navigation points on the Main Page, FIG. 1.

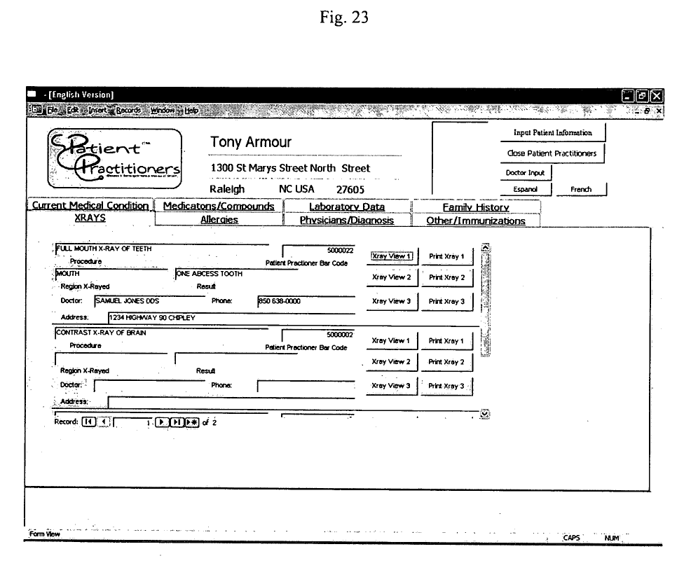

As disclosed for a preferred embodiment, the patient's allergy facts, entered into the Patient Input Screen, FIG. 3a, is presented for display within the Allergy screen, as shown in FIG. 23. As shown with respect to FIG. 3, a navigation point may be included to access the next or successive or second, screen FIG. 3a, for inserting additional patient personal information, as would be understood by those skilled in the art.

The patient's ID used as a data base key in a preferred embodiment is displayed in the data insertion display shown in FIG. 3.

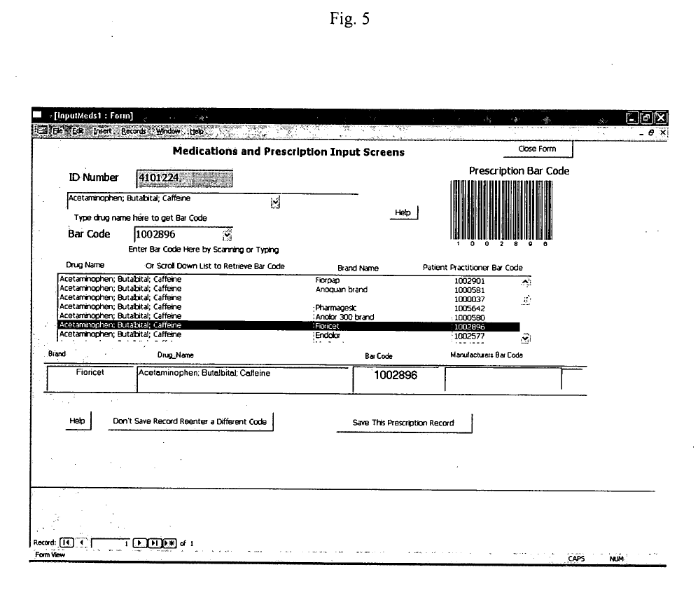

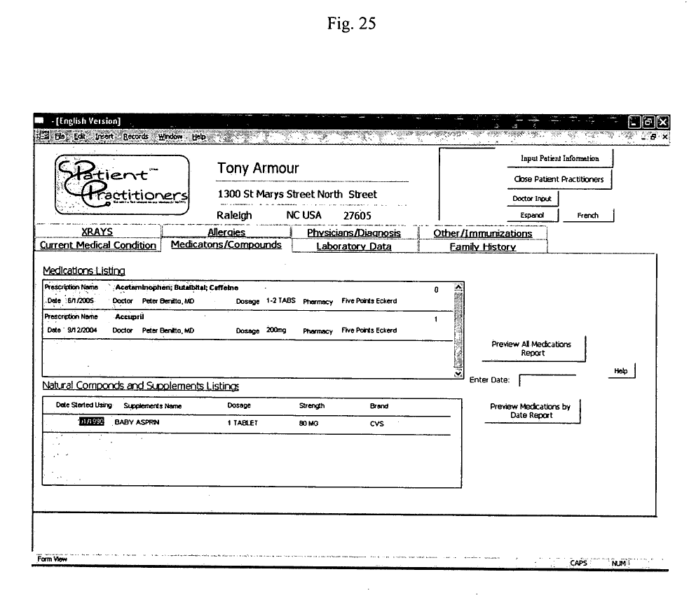

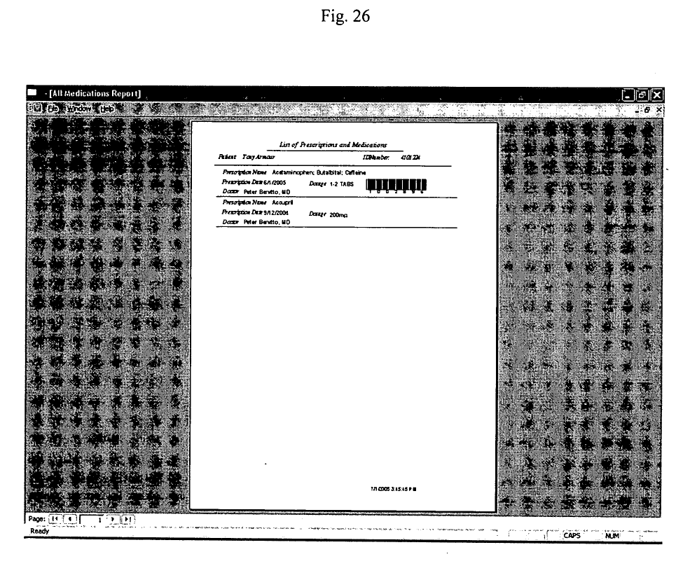

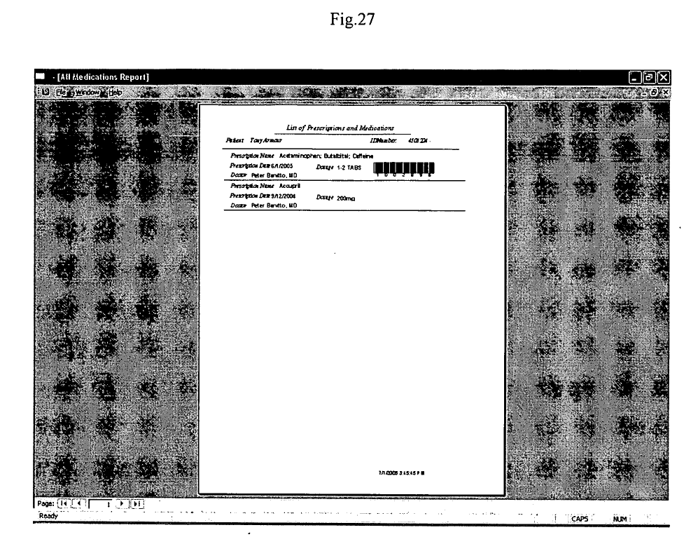

Returning to the Main Page screen as shown in FIG. 1, navigation points or buttons are shown for the selection of the general healthcare classification output display screens, FIGS. 22 to 32, 34, 36, 38, 40, used for the display of the specific healthcare facts for the patient within the respective general healthcare classifications. In a preferred embodiment, the display may be on a data display screen, or in a report, for example in a data display or by display or by printing of a printed report, including the respective bar codes for the reported data, as described herein, and as shown in FIGS. 26 and 27, for example. For example, information entered within the Patient Personal Information Input Form screen for Medicines and Prescriptions, as shown in FIG. 5, will appear in the Medications and Compound screen FIG. 25.

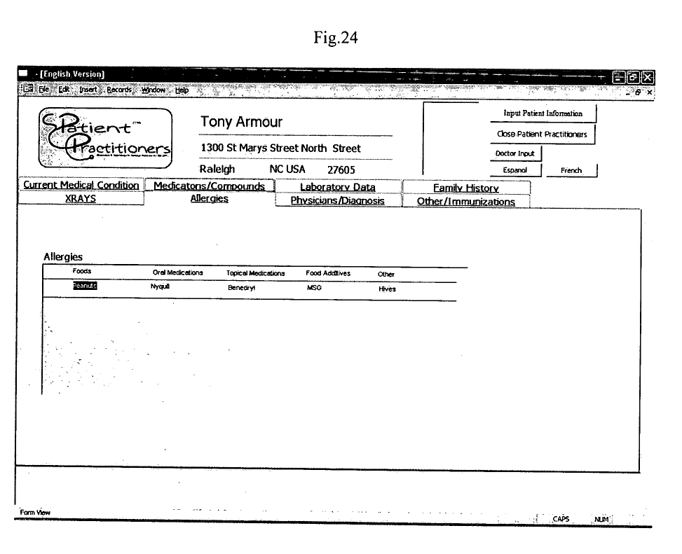

In a preferred embodiment, for example, navigation by the Allergies point on the Main Page, FIG. 1, produces the display of the allergy data entered in the allergy data fields in FIG. 3a, as shown on FIG. 24. In a preferred embodiment, the output displays for the general healthcare classification screens, as shown in FIGS. 22 to 34, 36, 38, 40, may comprise navigation points or buttons for each of the other general healthcare classification screens, and a direct and efficient navigation method and system directly between the separate respective general healthcare classification screens is made possible.

In a preferred embodiment, navigation to the Input Immunizations screen, FIG. 4, is from the Main Page, FIG. 1, to the Patient Information Input screen, FIG. 2, and general healthcare classification Input Immunization screen, FIGS. 4, using the Input Immunization navigation point. As shown for the Input Immunization general healthcare screen, as disclosed in a preferred embodiment, in FIG. 4, a list of standard or approved immunizations, may be provided for entry of the relevant dates and any other medical information, for example, reactions. The presentation of approved or accepted immunizations may be a series of pages or by a roll down menu, as would be known to, or understood by those skilled in the art.

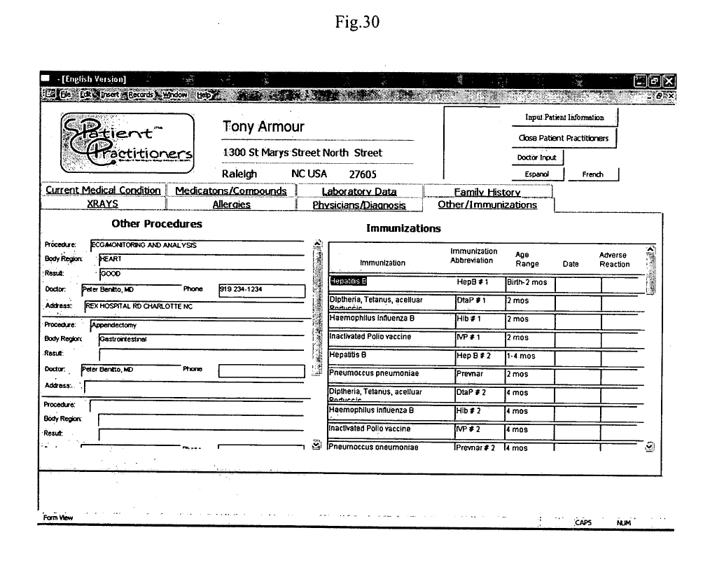

The data output display for immunizations, as shown for a preferred embodiment in FIG. 30 may be accessed, for example by the navigation point as shown in FIG. 1 for the Main page and when accessed, according to the disclose inventive principles, displays in a data output display or screen, the specific immunization healthcare facts in the general healthcare classification data input display, as shown in FIG. 4.

Navigation for inserting general healthcare data relevant to the patient's Medication and Prescriptions, is described above with reference to the insertion of specific healthcare facts or data for display in general healthcare classification screens for Medications and Prescriptions as shown in FIG. 25. As described with reference to data insertion and display for immunization, FIGS. 1, 2, and 4, navigation is through the Patient Information Screen, FIG. 2, by the Make a Record of Medications and Prescriptions navigation point, opening the Medications and Prescriptions Input screen, FIG. 5, for display in display output screen FIG. 26.

In a preferred embodiment, the masked screens for inserting medication and prescription, and other healthcare information, may display as a data base key, the general healthcare's identification number, which may be carried through all of the data base records as a data base key number, as would be known to those skilled in the art.

Selecting the Medications and Prescriptions Input screen, FIG. 5, consistent with others of the input screens shown for the Patient Information Input screen, in FIG. 2, may be by selecting the Make a Record of Medications and Prescriptions screen point in FIG. 2, as was shown above for the Input Immunization screen FIG. 4. FIG. 5, showing the Medications and Prescriptions Input screen for the insertion of healthcare data, discloses the principles of the disclosed invention, carried through others of the input screens, as shown in a preferred embodiment.

As shown in a preferred embodiment, the Medications and Prescriptions general healthcare classification data insertion screen, comprises data entry fields for data or information relevant to the specific healthcare facts to be entered within that general healthcare classification.

As shown in FIG. 5, the patient's ID number is carried through from the record entry as shown in the Main Page, FIG. 1. Specific healthcare facts are shown for the generic or trademark name for the drug to be entered, or by medicine brand name or by the corresponding bar code, entered in the designated respective data fields as shown in FIG. 5. A listing or menu of medications by drug or brand, name and by bar code is provided for identifying the specific healthcare medications. In a preferred embodiment, as shown in FIG. 5, identification of complete medicine and prescription drug, and brand name and bar code, may be by a known Drug Name, by Brand Name, or from the bar code.

The bar code may be entered by entering the correct bar code in the Bar Code data entry window, as shown, for example in FIG. 5, or by using a bar code reader as would be known to those skilled in the art, to scan the correct bar code from a prescription label or a printed report. Entry of the bar code produces the bar code graphic for the inserted bar code number. In preferred embodiments, the bar code is a seven (7) number code with the most significant number position, used to identify the separate respective categories of healthcare facts, for the respective general healthcare classification screens. As would be understood by those skilled in the art, another bar coding scheme may be used without departing from the disclosed inventive facts.

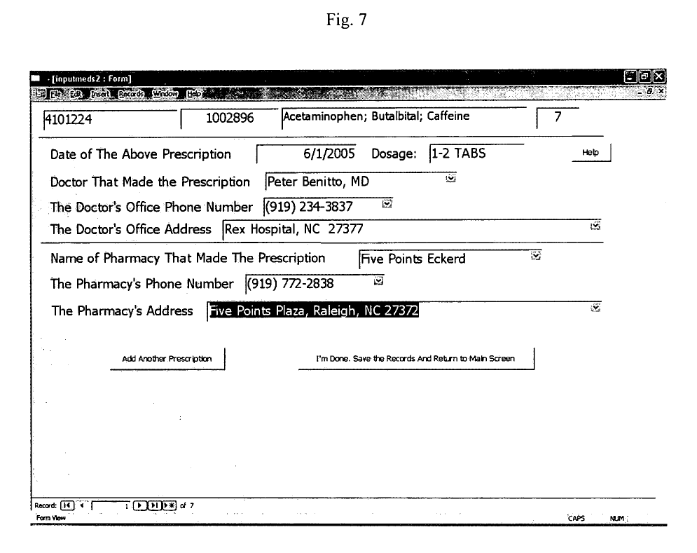

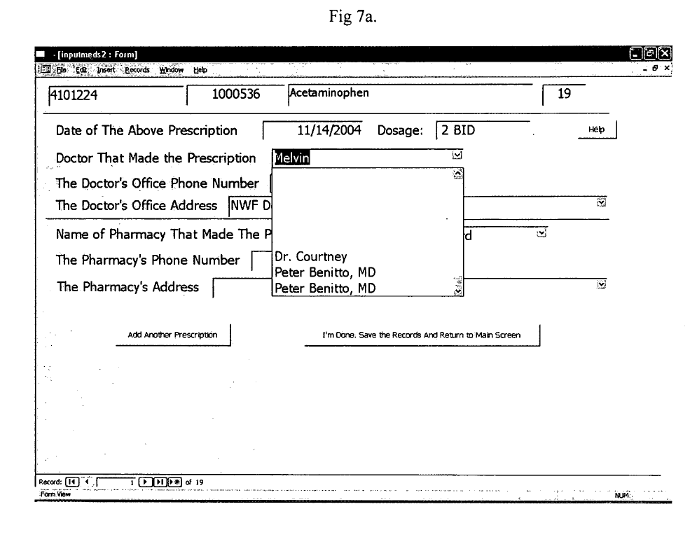

Upon entry of the bar code, for example for a respective medication, the bar code is displayed on the Medication and Prescription Input screen, as shown for example in FIG. 5. Entering the bar code or saving the entry using the Save Prescription navigation point, as shown for a preferred embodiment in FIG. 5, produces a secondary data entry screen FIG. 7, and the entry including its respective bar code can be reproduced in the Reports displayed for viewing and printings, as shown in FIG. 26 and FIG. 27 and described herein. Upon entering the bar code, the drug name, its brand name and bar code displayed.

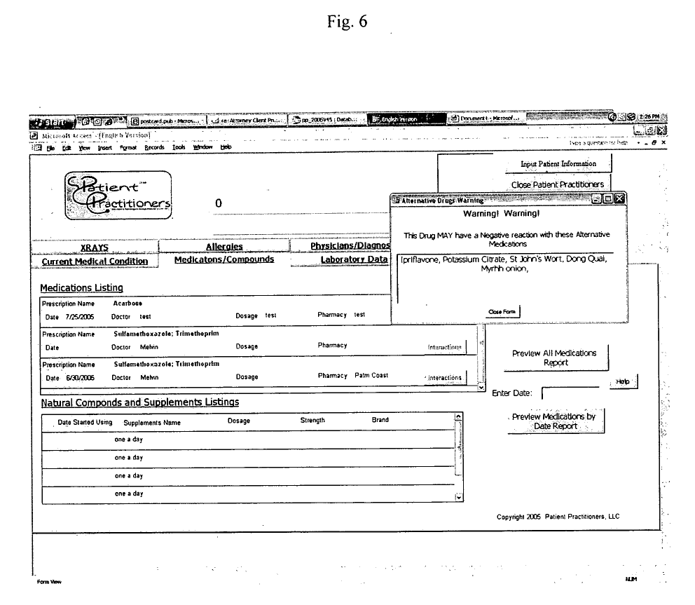

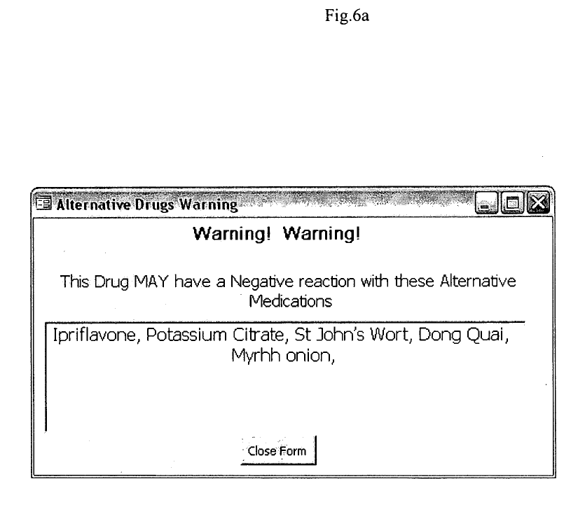

In connection with the disclosed inventive principles and as shown in a preferred embodiment, FIG. 6 shows a warning screen for a medication entered in the patient's data base. The invention, in connection with the disclosed inventive principles, comprises bar coded specific healthcare facts, within the data base records. For example, in a preferred embodiment, the bar coded health care facts for the general healthcare classification Medicines and Prescriptions, may comprise a bar encoded warning notice in connection with a drug, producing a warning or advisory notice through the data base data process, when the bar code for that drug or pharmaceutical, is entered, as described above.

As shown, for a preferred embodiment, in FIG. 6, by means of an overlay, an Alternative Drug Warning message displays a warning of an adverse or negative reaction with certain designated alternative medications. The connection of the bar coded warning notice to a medicine name by drug name or brand name or by relation to its bar code, may be by any suitable data relationship as would be known now or hereafter by those skilled in the art, without departing from the disclosed inventive principles.

For example, in FIG. 6, the warning notice for the bar encoded drug, Bar code1000024, Acarbose and showing an adverse reaction with alternatives Ipriflavone, Potassium Citrate, St. Johns Wort, Dong Qual, Myrrh Onion. The warning notice may be by an overlay or window or by a single warning notice, as shown in FIG. 6a, without departing from the disclosed inventive principles.

FIG. 7 shows a second or successive or sub, Medication and Prescription Input screen for adding relevant facts about prescription. For a preferred embodiment, the relevant information about the prescription, for example, the date, prescribing physician pharmacy, dosage, addresses and phone number, may be entered and as well, other information as would be understood by those skilled in the art.

As shown in a preferred embodiment, for example with respect to FIG. 7, the data base can preserve the names and other recurrently or repeatedly used data for example, the prescribing physician and dispensing pharmacy, which after the initial entry, may be stored and presented in a drop down menu for selection and entry into the respective data entry fields in the successive page for the Medication and Prescription Input, FIG. 7, as shown in FIG. 7a. The data inserted in the Medication and Prescription input display, are presented in the output display as shown, for example, in FIGS. 25 and in displayed bar coded reports for printing as shown in FIG. 26, 27. The reports may be produced by date of the specific healthcare fact data entry for the respective general healthcare classification, as shown in FIGS. 27.

The data base data process for embedding and connecting the bar coded medicine and drug warning notices and the drop down menus for repeated information, may be by any suitable known or known hereafter, data process, without departing from the disclosed inventive principles.

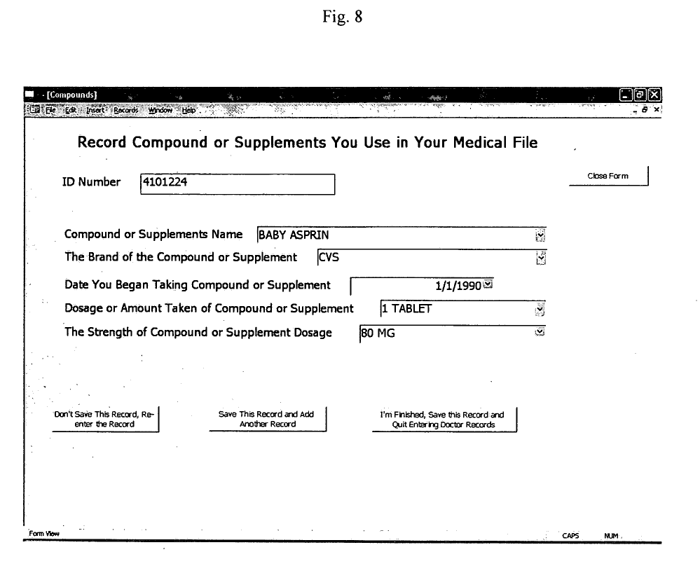

In the same way as shown for Immunizations and Medicines and Prescriptions, see FIG. 4, by selecting the navigation point in FIG. 2, for the selected general healthcare classification, for example, the data insertion display or screen, for Record of Supplements and Compounds You Use In Your Medical File input screen, may be accessed, as shown for a preferred embodiment by FIG. 8. The Supplements and Compounds You Use In your Medical File, data input display, for the insertion of healthcare data into the data base, is for display in the general healthcare classification data display screens, FIG. 25 to 27, for Medications/Compounds. As described above, the navigation point for Medications/Compounds general healthcare classification output display or screen may be accessed as shown for a preferred embodiment by the navigation point, as shown in FIG. 1.

The patients ID number serving as a data base key, is displayed in the ID data field for this input screen, shown in FIG. 8, as in others of the input screens, as disclosure of the inventive principles for a preferred embodiment. The display data entry fields are provided for compound or supplement name, its brand name, and for respective dates, dosages and strengths, inserted in the designated data fields as shown in FIG. 8. As would be understood by those skilled in the art, drop down menus may be provided with the names of supplements and compounds, for ease in data entry, as would be know to those skilled in the art.

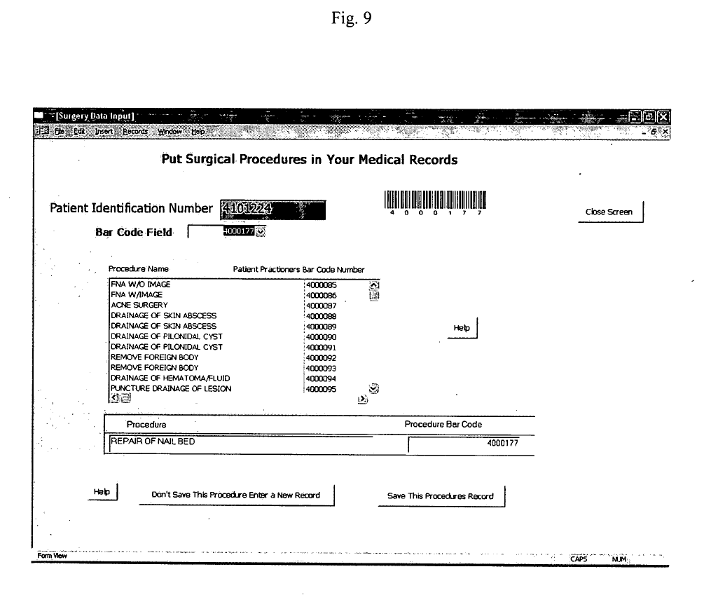

Selecting the Put Surgical Procedures In Your Input Files, FIG. 9, consistent with the navigation shown for others of the input screens shown for the Patient Information Input screen, in FIG. 2, and as described above for a preferred embodiment, may be by selecting the Make a Record of Surgical Procedures screen navigation point shown in the Patient Information Input Screen, FIG. 2. FIG. 9, shows the general healthcare classification Put Surgical Procedures In Your Input Files, data input display or screen, for the insertion of healthcare data for display in Main Page FIG. 1, as information appropriate for immediate display of the general medical condition of the patient, upon opening the data base.

As would be understood by those skilled in the art, the surgical procedure information may be displayed in a separate respective general healthcare classification screen for Surgical Procedures with its own navigation point on the Main Page, FIG. 1. In a similar manner, any of the other information arranged for display in a general healthcare classification screen, may be otherwise displayed on the Main Page, FIG. 1, without departing from the disclosed inventive principles.

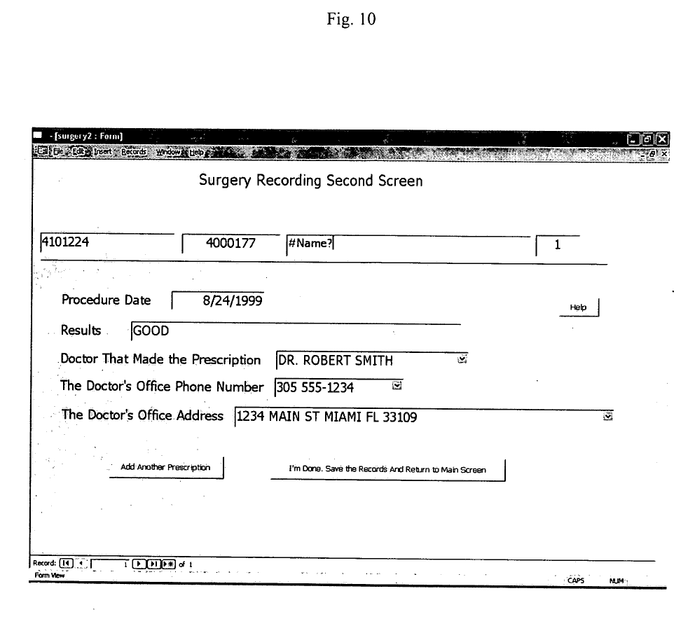

In accordance with a preferred embodiment, the patients ID number serving as a data base key, is displayed in the ID data field. Data entry fields are provided for the surgical procedure name and corresponding bar code. As described above with reference to Medications and Prescriptions, FIG. 7, a drop down menu can be provided for identification of the correct bar code from the list of displayed surgical procedures or the name of the surgical procedure may be entered to get the bar code. As shown in a preferred embodiment, the insertion of the selected surgical procedure into the data base for display in the respective window in the Put Surgical Procedures in Your Medical Records input screen, FIG. 9 and in continuation or second page, FIG. 10, for display in the Main Page, FIG. 1, follows from the insertion of the respective bar code into the bar code field, or by scanning the bar code from a printed report. The bar code, when inserted, is displayed in the input screen, as shown in FIG. 9, for viewing in a report display and for printing of the report, of all entries or of entries by date, as shown for example in the bar coded reports for Medications in FIGS. 26 and 27.

In summary, for inserting data related to surgical procedures, the bar code may be entered by using bar code reader as would be known to those skilled in the art, to scan the bar code from the doctor's printed report, or from the bar code in any printed report, as described herein. The same system and method may be used for others of the data input displays and screens, reports and without departing from the disclosed inventive principles.

A sub or successive screen, as shown in FIG. 10, may be used for inserting other related information, for example, the procedure date, and recurrent or repeated information for the Doctor. As shown above, the repeated or recurring information may be stored in a navigation drop down menu for selection and insertion into the data base, as would be know and understood by those skilled in the art.

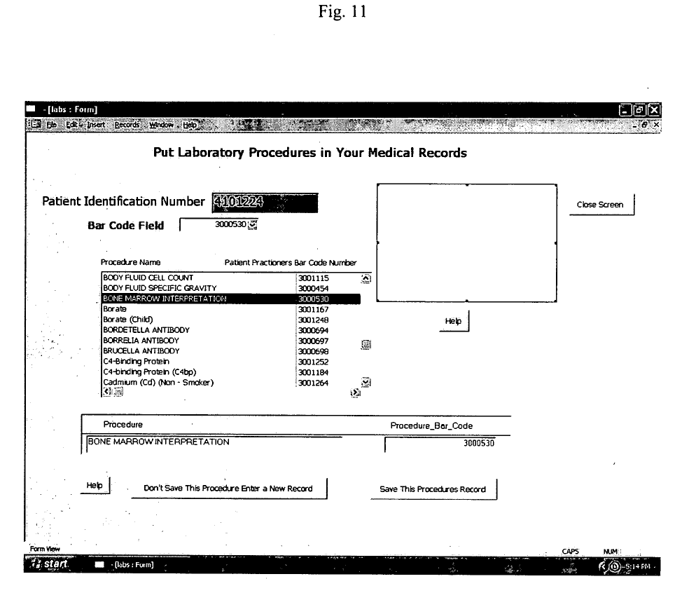

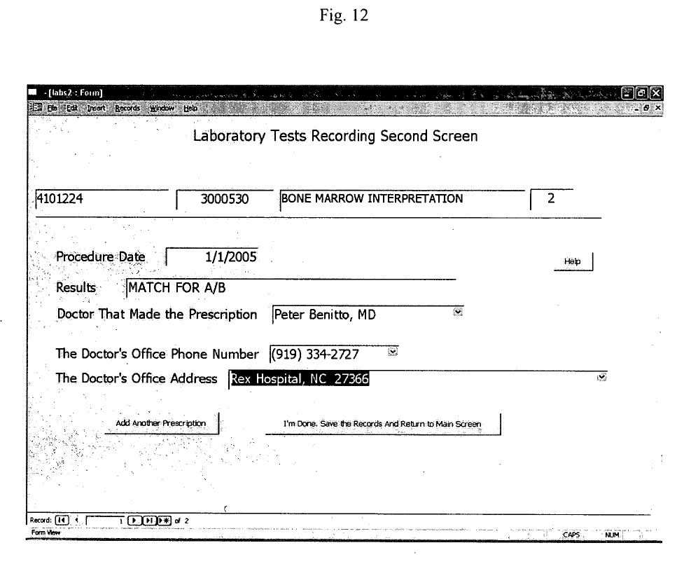

Selecting the Put Laboratory Procedures In Your Medical Records input screen, FIGS. 11 and 12, consistent with others of the input screens shown for the Patient Information Input screen, in FIG. 2, may be by selecting the Make a Record of Laboratory Procedures screen point in FIG. 2, as was shown above for the Input Immunization screen FIG. 4. The input screens Put Laboratory Procedures in Your Medical Records, for the insertion of laboratory procedure healthcare data, is shown for a preferred embodiment in FIG. 11 and sub or successive screen FIG. 12. The presentation of laboratory procedures and bar codes and the entry of the bar coded information, is the same or similar to the method and system described for surgical procedures, above, with respect to FIGS. 9 and 10.

As shown for the preceding input screens, the patients ID number serving as a data base key, is displayed in the ID data field. Data entry fields are provided for entries in the general healthcare classifications, for example, the laboratory procedure by name and by its bar code, which may be easily obtained by scrolling down through the scroll down list, shown in FIG. 11, to retrieve the bar code, and by inserting he bar code in the Bar Code Field. As shown for a preferred embodiment, the bar code for the designated laboratory procedure, may be inserted using bar code reader as would be known to those skilled in the art, to scan the bar code from a laboratory report or other printed report, into the data base page for the respective Laboratory Data general healthcare classification screen. As described above for other input screens, the bar code is produced in response to entering the bar code number, and may be used in producing printed reports of the related General healthcare Classification Laboratory Procedures data, as shown for example in FIGS. 26 and 27.

FIG. 12 shows a sub or successive data insertion display screen, in a preferred embodiments for example, in the Laboratory Tests Second Screen for the insertion of data related to the displayed laboratory procedure name and bar code, shown as the doctor and doctor's address and phone number. The repeatable data entered previously, for example relevant physician information, address and phone number, is retained in drop down menus adjacent the related data field for cursor selection of the physician, and address and phone number, from a drop down list, as described above for the insertion of repeated or recurring data, with reference to the second data insertion screen for 7a.

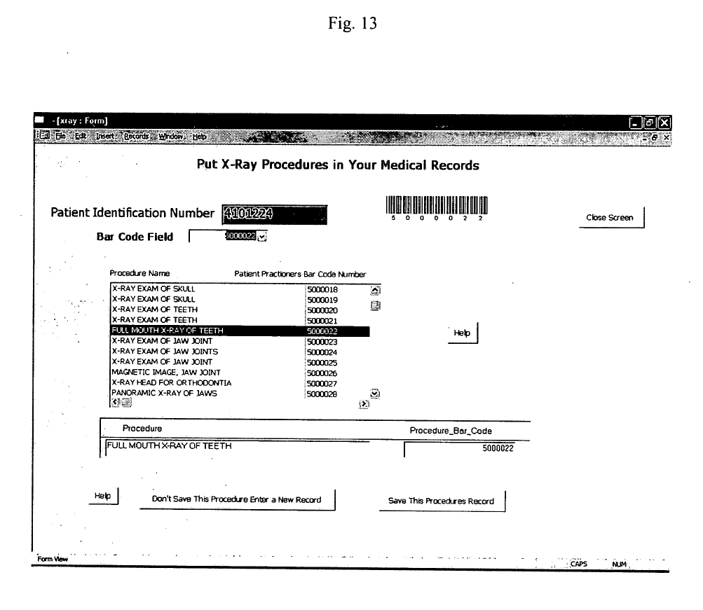

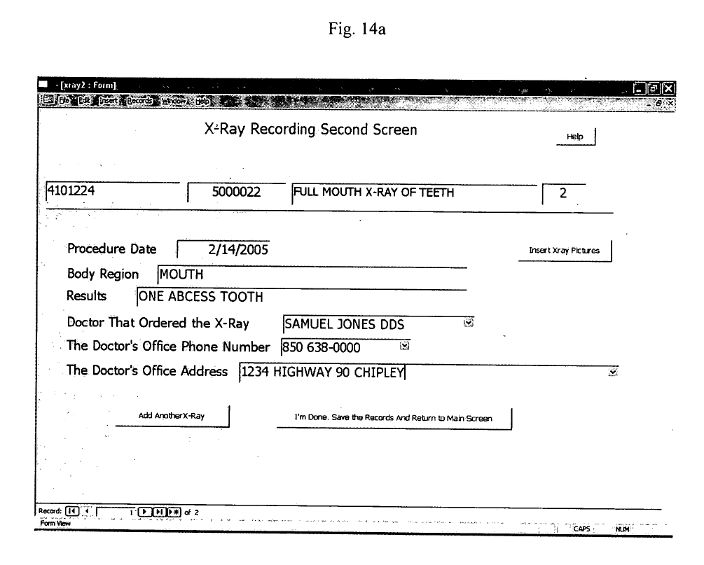

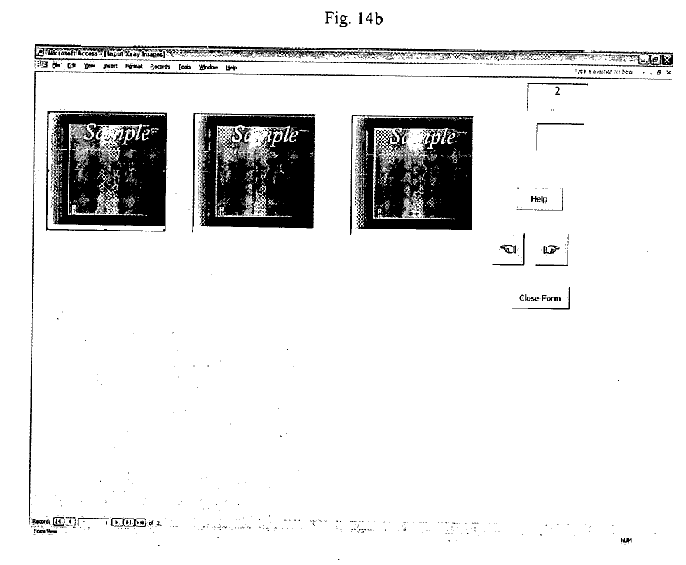

The insertion screens Put X-Ray Procedures in Your Medical Records, FIGS. 13 and 14a, may be accessed by the same system and method used for the described preceding data display input screens for surgical procedures and medicines and prescription, though the respective Make a Record of X-Ray Procedures point on the Patient Information Input Screen, FIG. 2. As shown in FIGS. 13 and 14a, the Patient Identification Number is displayed, with a scroll down menu for identification of the x-ray procedure and corresponding bar code. The display of the bar code and its name in the Procedure and Procedure Bar Code fields follows from the insertion of the bar code in the Bar Code field. Use of the bar code for display and in view and printed reports is as described above for bar code insertion and display, with respect to FIGS. 26 and 27.

A sub or successive data insertion screen X-Ray Recording Second Screen, FIG. 14a, displays the patient identity number, the x-ray procedure bar code and name, and data entry fields for procedure date, body region, results, and the recurring or redundant doctor information which may be provided in drop down menus for selection and insertion of the correct information, as described above. Navigation points are shown for displaying the x-ray digital information entered as described with respect to FIG. 14b.

In a preferred embodiment, the digital image information is individually placed into the records. To place an image or up to three images for an X ray in the records, as shown for a preferred embodiment, the digital image insertions screen as shown in FIG. 14b, may be used. As would be understood by those skilled in the art, a preferred embodiment may have the facility to put more than three X ray images in the records.

As shown for the disclosed inventive principles, a digital image of an x-ray may be inserted into the data base by selecting the Insert X-Ray Picture point in the X-Ray Recording Second Screen, FIG. 14a, producing an insertion screen 14b, for the Input X-Ray Images For This Record, navigation point. By navigating through the View window selected for x-ray image insertion, as a navigation point, a digital file representing the object x-ray image selected for insertion, may be identified and inserted using methods for inserting .jpg, .bmp, or .tif, images, as would be known to those skilled in the art. The inserted x-ray image may be displayed as shown and described with reference to FIG. 23. Using a “cut and paste,” technique, as known to those skilled in the art, digital image data may be copies from a file into the data base for display in the x ray image display as shown in a preferred embodiment, in FIG. 23.

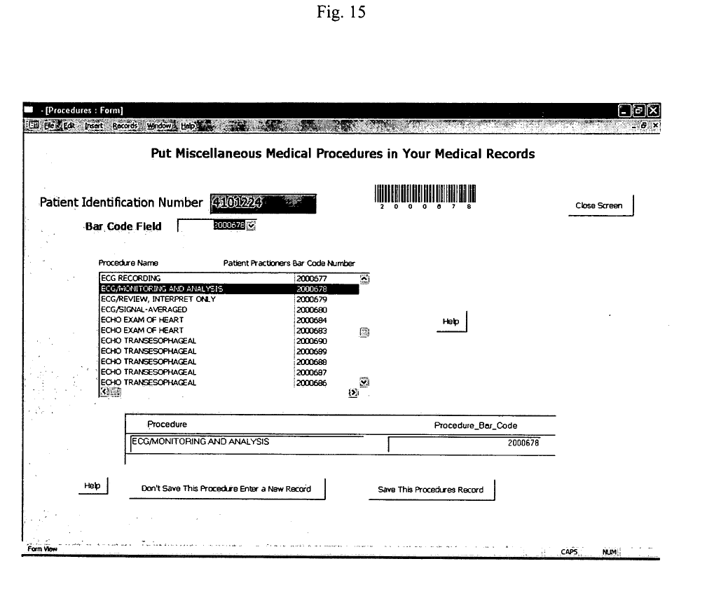

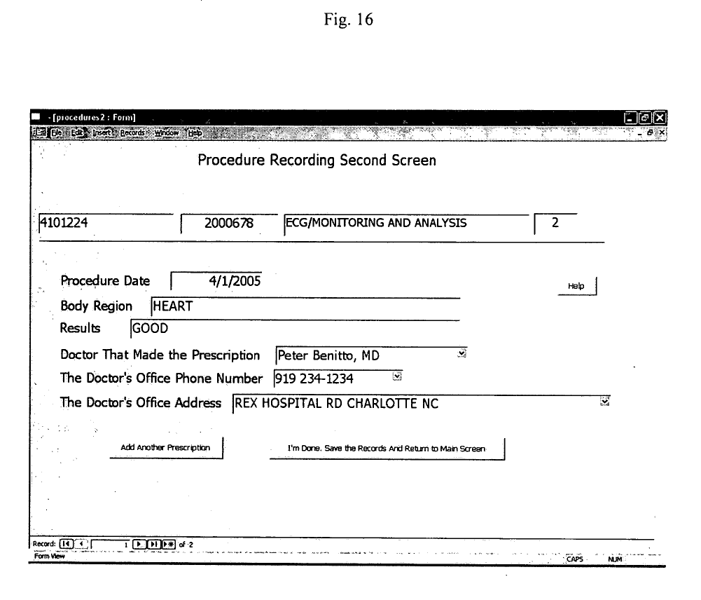

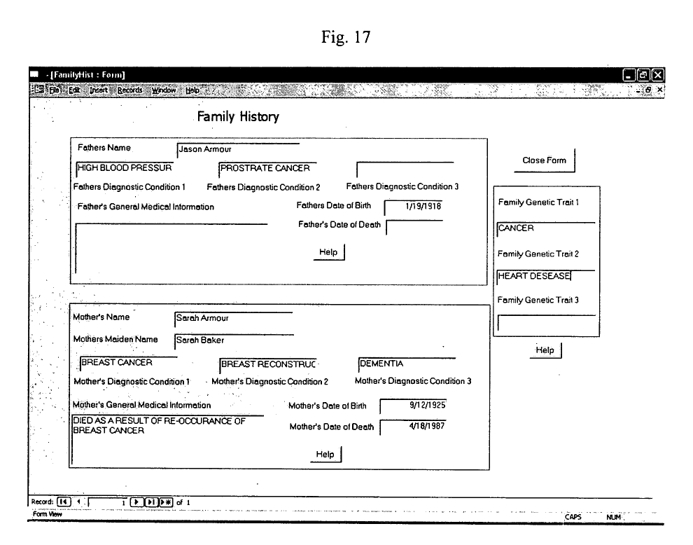

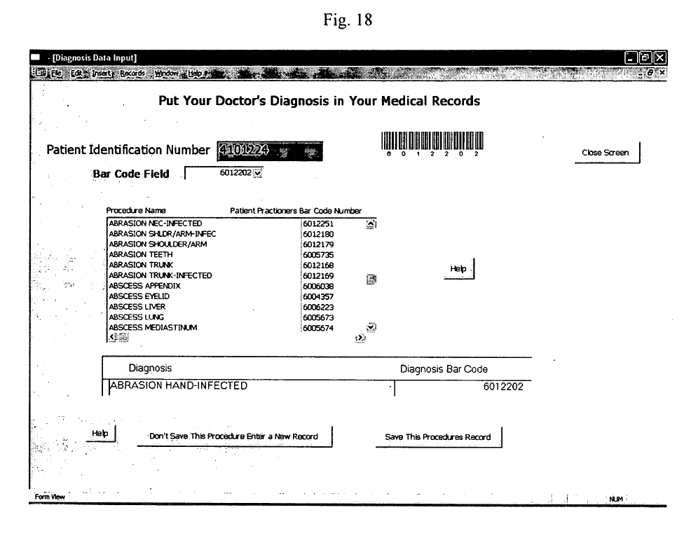

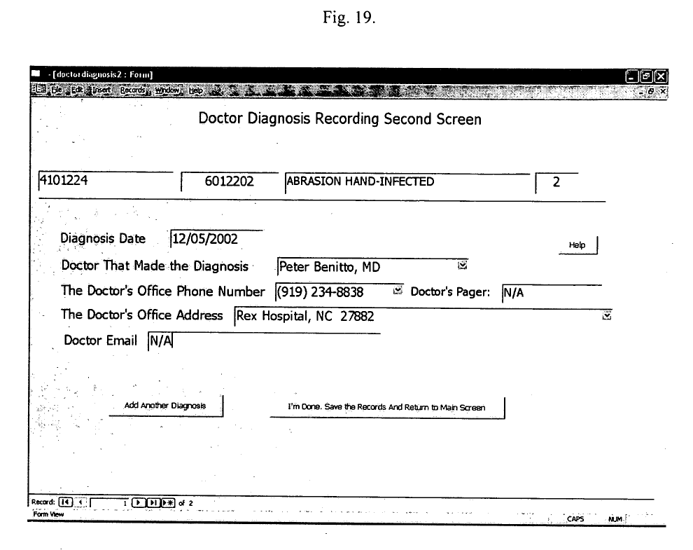

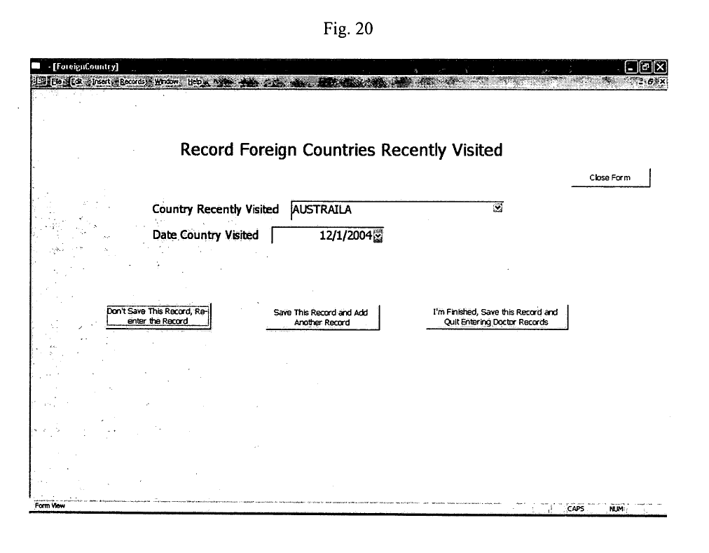

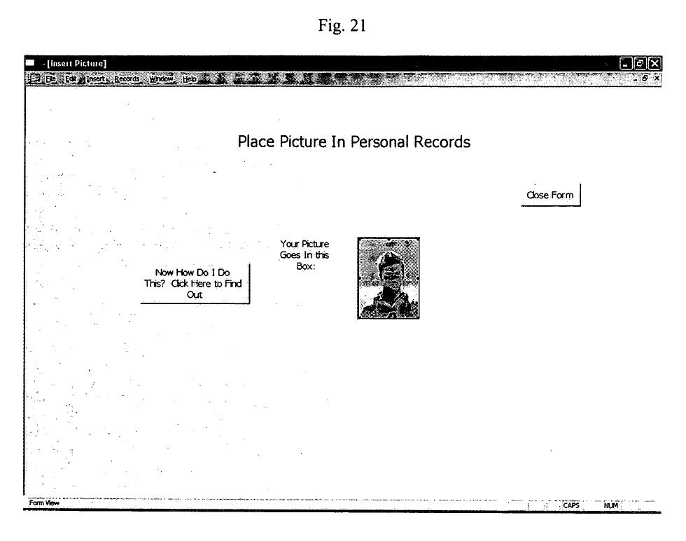

Similarly to the others of the input screens, as described above, by navigation through the Patient Information Input Screen navigation points, FIG. 2, to the Make a Record of Medical Procedures Other Than Surgery and X-Rays point, to the Put Miscellaneous Medical Procedures in Your Medical Records input screens, FIG. 15, and sub or successive screen FIG. 16, to the Family History input screen, FIG. 17, through the Doctor's Diagnosis, FIGS. 18, 19, and Record Foreign Countries Recently Visited, FIG. 20. The data to be inserted in the respective data entry fields is as described above with reference to other similar data entry fields. By navigating through the Insert a personal Photograph In The Records, see FIG. 21, an insertion screen,, with an open window for insertion of a digital image as described with reference to insertion of x-ray images, above.

Similarly, with reference to Family History, FIG. 17, by a navigation point “DNA,” and use of a digital image, as would be known to those skilled in the art, an image of a DNA report may inserted, for example, as described with reference to FIG. 14b, for x-rays or for a photo as described with reference to FIG. 21.

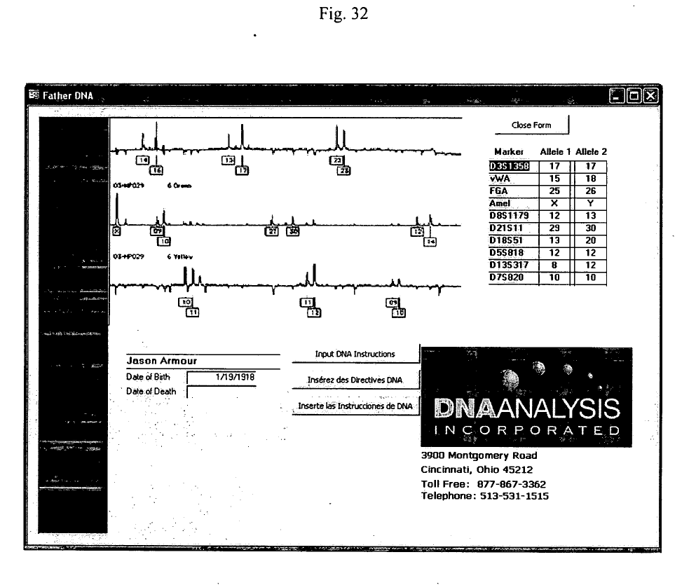

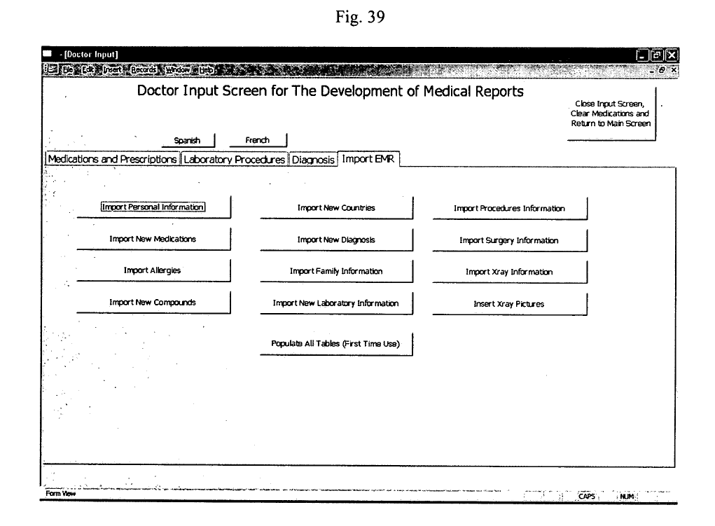

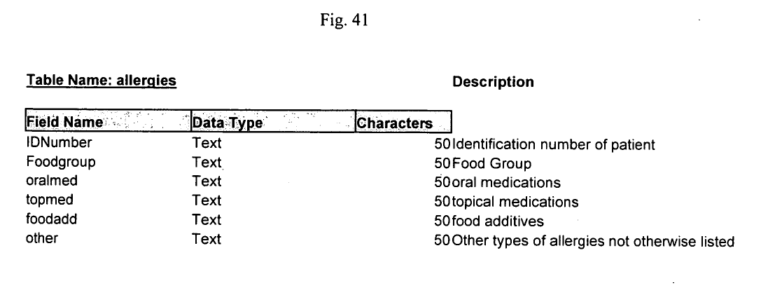

Access to the Doctor Input Screen For The Development of Medical Reports, FIGS. 32, 34, 36, 38, including display output screens, is through the navigation point Doctor Input, on the Main Page, FIG. 1. By navigating through the respective points for Medications and Prescriptions, Laboratory Procedures and Diagnosis, and the successive or sub screens are produced with drop down lists for respective Medications and Prescriptions, Laboratory Procedures, Diagnosis, and Import EMR, for selection by a Doctor and use in a printed report, for example, as shown in FIGS. 26, 27. In connection with Import EMR, FIG. 39, the data insertion screen is a presentation of navigation points to the patient's respective general healthcare classifications for import of specific healthcare facts to the respective general healthcare classifications or exporting in the reverse process to the Doctor's general healthcare classifications for the patient. As would be understood by those skilled in the art, data transfer between a practitioner's EMR and the patient's data base would be by compatible data bases or processes to arrange the respective data bases in formats compatible for data transfer. As would be understood by those skilled in the art, a selection of data within a general healthcare classification for import from the patient data base to the practitioner EMR may be made for example by date of prescription or date of surgery of by the bar codes used to enter the specific healthcare fact into the patient data base. As would be understood by those skilled in the art, selections of specific healthcare facts for importing or exporting, may be by any of the data fields in any of the data base tables, for example the Allergies table as shown in FIG. 41.

As would be understood by those skilled in the art, suitable data base table formats may be created in the practitioner EMR, as shown, for example in FIG. 41, for the Allergies table. Data transfer by export or import, between the patient database and the practitioner EMR is well known to those skilled in the art.

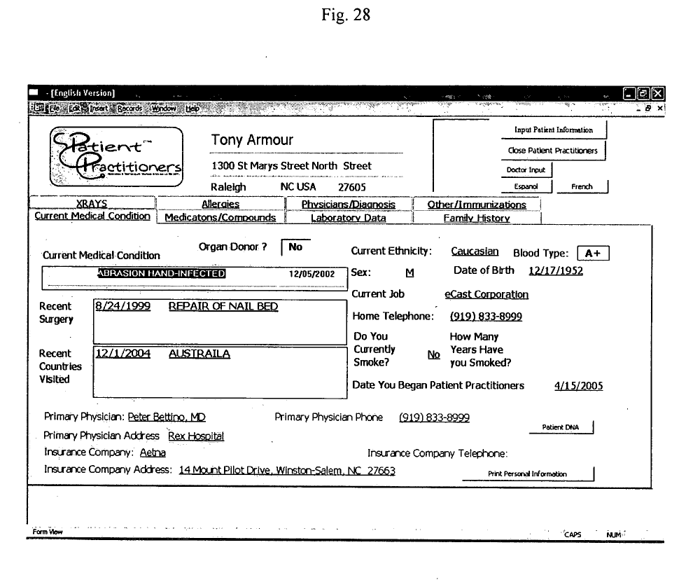

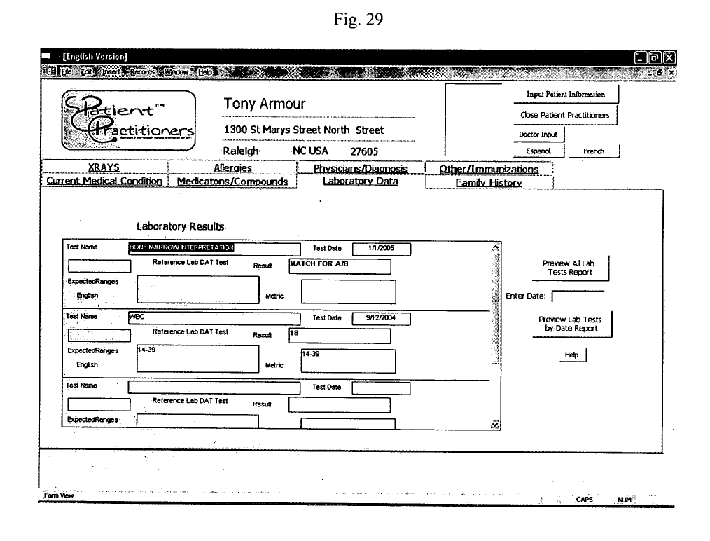

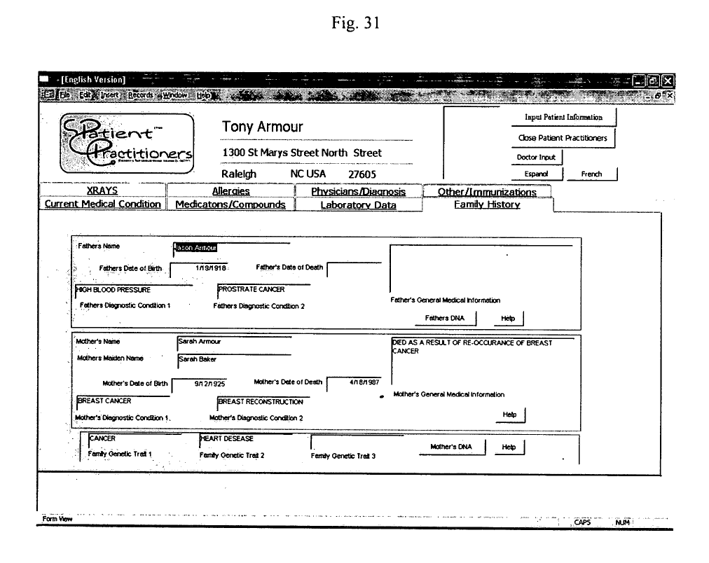

By navigating through the Main Page, See FIG. 1, and the Patient Input information screen, FIG. 2, navigation points for X-Rays, Current Medical Conditions, Allergies, Surgeries, Medications/Compounds, Physicians-Doctor's Diagnosis, Laboratory Data, Other/immunizations, and Family History, for example, the respective general healthcare classification healthcare data displays will be produced, as shown in FIGS. 22 to 32 for general patient information and medical condition, FIG. 22, x-ray information, FIG. 23, Allergies, FIG. 24, Medications and compounds, FIG. 25 and bar coded reports as shown in FIGS. 26, 27, the doctor's or physicians diagnoses, as shown in FIG. 28, Laboratory data, as shown in FIG. 29, Immunizations, as shown in FIG. 30, Family History, as shown in FIG. 31, DNA analysis, as shown in FIG. 32.

In connection with the Doctor's Diagnosis entered, through the data insertion display, FIG. 18, the diagnosis is displayed in the Current Medical Condition display output in the Main Page, FIG. 1, as disclosed for a preferred embodiment.

A DNA record may be inserted using the Family History data insertion display, by selection of the DNA navigation point. The displayed DNA analysis graphic is displayed, in a preferred embodiment, in the output display for the DNA graphic as shown in FIG. 31.

In each of the general healthcare classification display screens, FIGS. 22 to 34, 36 and 38, the data inserted into the input screens, as described above will be produced, including a photo of the patient and the patient's x-rays and DNA analysis, as described with reference to the respective data display output scar

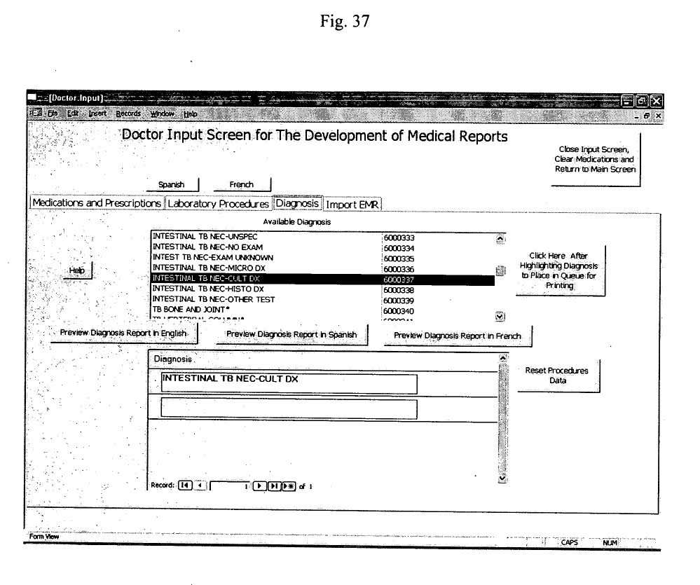

Separate data insertion displays are provided for entry directly by a doctor/physician, as shown for the Development of Medical Reports—Medications and Prescriptions, with reference to FIG. 33, for Development of Medical Reports—Laboratory Procedures, 35, and for Development of Medical Reports—Diagnosis, as shown with reference to FIG. 37. FIG. 39, as discussed above is doctor's/physician's input display navigation screen for importing specific healthcare facts with respect to patient information from the data base general healthcare classifications. As would be known to those skilled in the art, any suitable data process, known now or hereafter, may be used for the importing and exporting of patient specific healthcare facts between a patient's personal transportable data base and a physician's EMR.

As shown and described, with reference to a preferred embodiment, the data base and data processes for recording, and ordering the data within the data base and for displaying the data, may be practiced with any suitable data base system and method, and as may be used with any suitable data processor, as may be known or developed hereafter.

What is claimed is:

1. A personal portable patient healthcare data base program, comprising,
a patient data base arranged in patient identifiable relatable records;
a data input process including a data insertion display and a data output process including a data output display;
a data process connecting said records with said data insertion display and said data output display;
at least one of said records comprising bar coded healthcare facts for a plurality of general healthcare classifications and for respective specific healthcare facts within said general healthcare classifications;
said wherein said data process comprises a process for placing in at least one of said relatable records identified with a respective general healthcare classification, a specific healthcare fact responsive to the insertion in said data insertion display of a respective bar code for a said bar coded healthcare fact.

2. The data base program of claim 1, comprising a process identifying a bar code for a specific healthcare fact entered in said data insertion display or a specific healthcare fact for a bar code entered in said data insertion display.

3. The data base program of claim 2, wherein said data input display for a respective general healthcare classification, displays a plurality of specific health care facts and respective bar codes for said healthcare facts.

4. The data base program of claim 1, comprising a process for arranging said specific healthcare facts for a respective general healthcare classification, in a report and said data output display includes a bar code for at least one said specific healthcare facts.

5. The data base program of claim 1, comprising a process for reading a bar code from said bar coded information, and inserting said specific healthcare fact for said bar code into the corresponding general healthcare classification for said bar code.

6. The data base program of claim 1, wherein said data insertion display comprises at least one data input display for a respective general healthcare classification and a process presenting a plurality of bar coded specific healthcare facts for said respective general healthcare classification.

7. The data base program of claim 1, wherein at least one said data output display includes a plurality of navigation points; said data base includes a process for opening a respective output display for a general healthcare classification corresponding to at least one of said navigation points.

8. The data base program of claim 7, wherein at least one of said navigation points corresponds to a patient information input data insertion display.

9. The data base program of claim 8, wherein said patient information input data insertion display comprises a plurality of data input navigation points for respective general healthcare classifications data input displays.

10. The data base program of claim 1, wherein at least one of said input displays includes a process for inserting graphic images in said relatable records, produced by a physiological exposure to electrical, light, or magnetic, waves, or sound waves, or from an analysis of biological material.

11. The data base program of claim 1, comprising,
a data process for importing or exporting specific healthcare facts between a patient data base and a practitioner or doctor data base.

12. The data base program of claim 11, wherein said data process for importing or exporting specific health care facts, comprises a data process for a selection of respective general healthcare classifications.

13. The data base program of claim 11, wherein said data process for importing or exporting specific health care facts, comprises a data process for selecting specific healthcare facts, within a respective general healthcare classifications.

14. The data base program of claim 1, wherein, said data output process includes a screen display to display specific healthcare facts for at least one of said general healthcare classifications and at least one navigation point to a said data input display.

15. The data base program of claim 1, wherein said data input process comprises a process for storing for selection, information repeatedly entered for specific healthcare facts, and presenting said repeatedly entered information for selection and insertion in a respective record.

16. The data base program of claim 1, comprising at least one notice associated with a respective bar coded specific healthcare fact; said data output process comprises a process for displaying in said data output display, said at least one notice, in response to insertion of a said bar code for said respective bar coded specific healthcare fact in said data input display.

17. The data base program of claim 16, wherein said notice displays information for a medicine or supplement, specific healthcare fact.

18. The data base program of claim 1, comprising,
a practitioner or doctor data input process comprising doctor's records; a plurality of doctor data insertion displays for respective general healthcare classifications; said data process connecting said doctor's records with said data insertion display.

19. The data base program of claim 18, wherein said doctor data input process comprises,
a data input display for the development of medical records, or a data process for importing specific healthcare facts for a respective general healthcare classification from said patient data base to said doctor's records.

20. The data base program of claim 19, comprising a process for arranging said specific healthcare facts for a respective general healthcare classification, in a report and said data output display includes a bar code for at least one said specific healthcare fact.

21. The data base program of claim 1, comprising a main page data output display for displaying respective data for a patient's general condition, or surgeries, or a patient photo, or date of birth, or blood type, or contact information, or recent countries visited, or organ donor or not or smoker or not, or contact information for a primary physician, or navigation points to data output displays for x rays, or allergies, or physician diagnosis, or laboratory data, or family history, or recent DNA, or Medications or Compounds, or immunizations.

22. The data base program of claim 1, wherein said bar coded healthcare facts are for respective general healthcare classifications of medications, or prescriptions, or surgical procedures, or laboratory procedures, or x-ray or miscellaneous medical procedures or doctor's diagnosis.

23. The data base program of claim 18, comprising at least one notice associated with a respective bar coded specific healthcare fact; said data output process comprises a process for displaying in said data output display, said at least one notice, in response to the insertion of a said bar code in said input data display corresponding to said respective bar coded specific healthcare fact.

24. The data base of claim 16, wherein said data output process comprises a process for displaying in said data output display, at least one said notice, in response to a said bar code for a specific healthcare fact and a respective general healthcare classification, inserted in said data input display for a separate respective general healthcare classification.

25. The data base of claim 16, wherein said notices comprises information of an adverse response, outcome, or reaction, to, or for, or from, one or more specific healthcare facts, in response to the insertion of a said bar code for a said respective healthcare fact.

26. The data base of claim 25, wherein, said notices comprise information of an adverse outcome for a surgical or other procedure, or from a medication or pharmaceuticals, or to an immunization.

27. A personal portable patient healthcare data base program, comprising,
data processing means;
said data processing means comprising means for storing and accessing, a data base arranged in patient identifiable relatable records;
means for a data input process including a data insertion display and a data output process including a data output display;
means for a data process connecting said records with said data insertion display and said data output display;
means for at least one of said records comprising bar coded healthcare facts for a plurality of general healthcare classifications and for respective specific healthcare facts within said general healthcare classifications; and
wherein said means for a data process comprises a process for placing in at least one of said relatable records identified with a respective general healthcare classification, a specific healthcare fact corresponding to the insertion in said data input display of a bar code for a respective bar coded healthcare fact.

28. A method for a personal portable patient healthcare data base program, comprising the steps of, arranging a data base arranged in patient identifiable relatable records; providing in said data base, a record of bar coded healthcare facts comprising specific healthcare facts within respective general healthcare classifications; placing in at least one of said relatable records identified with a respective general healthcare classification, a specific healthcare fact corresponding to the insertion of a bar code for a respective bar coded specific healthcare fact.
